(19) United States
(12) Patent Application Publication
(10) Pub. No.: US 2015/0168618 A1
(43) Pub. Date: Jun. 18, 2015

(54) INFRARED SHIELDING BODY

(71) Applicant: Konica Minolta, Inc., Tokyo (JP)

(72) Inventor: Akihisa Nakajima, Tokyo (JP)

(21) Appl. No.: 14/403,738

(22) PCT Filed: May 16, 2013
(86) PCT No.: PCT/JP2013/063671

§ 371 Date: Nov. 25, 2014

(30) Foreign Application Priority Data
May 31, 2012 (JP) 2012-124799

(51) Int. Cl. G02B 5/28; G02B 1/04

(52) U.S. Cl. CPC G02B 5/282; G02B 1/04

(57) ABSTRACT

Provided is an infrared shielding body in which film cracking of a dielectric multilayer film is suppressed even under severe conditions. The present invention relates to an infrared shielding body having a wavelength exhibiting a maximum reflectivity in the range of 850 nm to 1500 nm in a reflection spectrum of a wavelength from 400 nm to 2500 nm, the infrared shielding body comprising a first reflective film, a light incoherent layer, and a second reflective film laminated in this order, wherein the first reflective film and the second reflective film contain a polymer and metal-containing particles.

### TECHNICAL FIELD

The present invention relates to an infrared shielding body.

### BACKGROUND ART

In recent years, window films to be attached to a window glass surface of buildings and motor vehicles have been frequently used. As one of the window films, there is a film which serves to suppress penetration of infrared rays and to prevent a building indoor temperature from excessively rising, and thus energy saving by reduction in the use of air conditioning has been achieved.

As a window film for cutting infrared rays, (1) an infrared absorbing type film obtained by forming an infrared absorbing layer containing an infrared absorber on a film, (2) an infrared reflective type film obtained by forming an infrared reflective layer on a film, and a film of a type which is provided with both the functions have been commercially available.

There is a problem in the (1) film that sunlight in a near-infrared region does not enter into a room directly but is absorbed and saved in the film as heat, and the heat enters into the room eventually. On the other hand, a metal film is used in the (2) film and thus a reflection region is extended to a visible light region, as a result there is a problem that the landscape is impaired, and radio waves are blocked between the indoor and the outdoor and thus a mobile phone can not be used indoors. In addition, there has been a film using reflection of a so-called dielectric multilayer film provided with a plurality of layers having different refractive indices as an infrared reflective film using a film other than the metal film.

As the dielectric multilayer film, there has been also a metal oxide film formed by a sputtering method that has been commonly used in lens processing. However, it is difficult to form a dielectric multilayer film uniformly in a large area by the sputtering method, and when a metal oxide film is formed on a plastic film as a support, like the near-infrared reflective film, there is a problem that the support is deformed by heat or the like during the sputtering and breaking or cracking occurs in the film.

As a method for solving such a problem, a near-infrared reflective film obtained by multilayer coating with an aqueous coating liquid containing a resin and inorganic particles has been proposed (see JP-A-2012-71446). According to this method, there are advantages that it is possible to increase infrared reflectivity by increasing a refractive index difference between layers having different refractive indices by adding inorganic particles, cracking in a coating film due to folding or the like is less likely to occur since the resin and the like has flexibility, or the like.

### SUMMARY OF INVENTION

However, it has been found that there is a problem in the near-infrared reflective film of the related art described above that the dielectric multilayer film cracks under severe conditions, for example, in the case of being exposed to a high temperature and high humidity, film cracking occurs as a result. For the near-infrared reflective film that can transmit a visible light region and thus enables to look at the landscape therethrough, landscape disturbance due to film cracking is a fatal problem.

Accordingly, an object of the present invention is to provide an infrared shielding body in which film cracking of a dielectric multilayer film is suppressed even under severe conditions.

The present inventors have conducted extensive studies in view of the above problems. As a result, it has been surprisingly found out that the above problem is solved by an infrared shielding body comprising a light incoherent layer disposed between a first reflective film and a second reflective film which contain a polymer and metal-containing particles, to complete the present invention.

Specifically, the above object of the present invention can be achieved by the followings.

1. An infrared shielding body having a wavelength exhibiting a maximum reflectivity in the range of 850 nm to 1500 nm in a reflection spectrum of a wavelength from 400 nm to 2500 nm, the infrared shielding body comprising a first reflective film, a light incoherent layer, and a second reflective film laminated in this order, wherein the first reflective film and the second reflective film contain a polymer and metal-containing particles.

2. The infrared shielding body according to the 1. above, wherein the first reflective film is an alternately laminated body of a layer (A) containing at least polyvinyl alcohol (a) and silicon oxide particles and a layer (B) containing at least polyvinyl alcohol (b) having a saponification degree different from that of the polyvinyl alcohol (a) and titanium oxide particles, and the second reflective film is an alternately laminated body of a layer (C) containing at least polyvinyl alcohol (c) and silicon oxide particles and a layer (D) containing at least polyvinyl alcohol (d) having a saponification degree different from that of the polyvinyl alcohol (c) and titanium oxide particles.

3. infrared shielding body according to the 1. or 2. above, wherein the first reflective film and the second reflective film have a laminated structure having 15 or more layers.

### BRIEF DESCRIPTION OF DRAWINGS

FIG. 1 is a schematic cross-sectional view illustrating an infrared shielding body according to an embodiment of the present invention.

### DESCRIPTION OF EMBODIMENTS

The infrared shielding body according to the present invention is an infrared shielding body having a wavelength exhibiting a maximum reflectivity in the range of 850 nm to 1500 nm in a reflection spectrum of a wavelength from 400 nm to 2500 nm, the infrared shielding body comprising a first reflective film, a light incoherent layer, and a second reflective film laminated in this order, wherein the first reflective film and the second reflective film contain a polymer and metal-containing particles. By such a constitution, film cracking of a dielectric multilayer film is suppressed even though the infrared shielding body of the present invention is exposed under severe conditions. Moreover, distortion hardly occurs in an image seen through the infrared shielding body.

Surprisingly, the present inventors have succeeded in suppressing film cracking of the infrared shielding body by adopting the constitution described above to an infrared shielding body.

Hitherto, although various types of infrared shielding bodies (reflectors) have been devised, it has not been able to suppress film cracking even with a constitution in which a metal film or a dielectric multilayer film containing a polymer is simply sandwiched between light incoherent layers. However, it has succeeded in suppressing film cracking for the first time by laminating the first reflective film, the light incoherent layer, and the second reflective film of the present invention in this order.

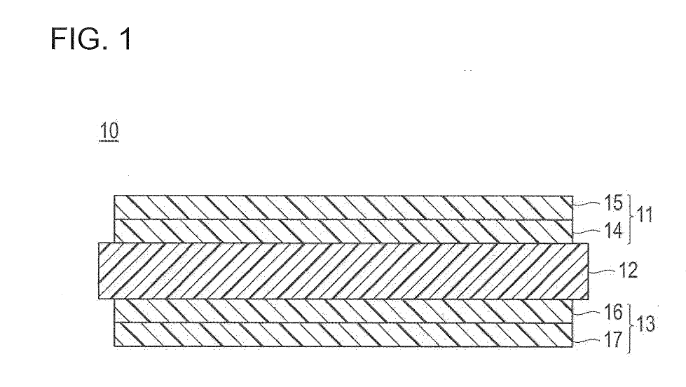

FIG. 1 is a schematic cross-sectional view illustrating an infrared shielding body according to an embodiment of the present invention. An infrared shielding body 10 illustrated in FIG. 1 comprises a first reflective film 11, a light incoherent layer 12, and a second reflective film 13 laminated in this order. In the embodiment illustrated in FIG. 1, the first reflective film 11 is a laminated body of a layer (A) 14 containing at least polyvinyl alcohol (a) and silicon oxide particles and a layer (B) 15 containing at least polyvinyl alcohol (b) having a saponification degree different from that of the polyvinyl alcohol (a) and titanium oxide particles. Similarly, the second reflective film 13 is a laminated body of a layer (C) 16 containing at least polyvinyl alcohol (c) and silicon oxide particles and a layer (D) 17 containing at least polyvinyl alcohol (d) having a saponification degree different from that of the polyvinyl alcohol (c) and titanium oxide particles.

In the infrared shielding body according to the present invention, the wavelength exhibiting the maximum reflectivity is in the range of 850 nm to 1500 nm in the reflection spectrum of the wavelength from 400 nm to 2500 nm. In this range, a visible reflection color does not appear even when the film is viewed from an oblique side (for example, 45 degrees). If the wavelength exhibiting the maximum reflectivity is less than 850 nm, a visible reflection color is recognizable when the film is viewed from an oblique side. On the other hand, thermal barrier effect decreases when the wavelength exhibiting the maximum reflectivity is greater than 1500 nm, since intensity of light having a wavelength close to a visible light region is strong in the wavelength dispersion of sunlight. The wavelength exhibiting the maximum reflectivity is preferably in the range of 900 to 1300 nm. Meanwhile, the reflection spectrum can be measured by the method described in Examples.

In addition, in the infrared shielding body of the present invention, it is better as a peak half value width of the wavelength exhibiting the maximum reflectivity is wider and the peak half value width is preferably in the range of 150 to 700 nm, since it would not be possible to reflect the near-infrared rays efficiently when the peak half value width is narrow.

A transmittance of visible light region of the infrared shielding body of the present invention, which is indicated by JIS R3106: 1998, is preferably 30% or more and more preferably 60% or more.

Hereinafter, the light incoherent layer, the first reflective film, and the second reflective film which are constituent elements of the infrared shielding body of the present invention will be described in detail.

[Light Incoherent Layer]

The light incoherent layer used in the infrared shielding body of the present invention is sandwiched between the first reflective film and the second reflective film, and is not particularly limited, but is preferably a film support. The film support may be transparent or opaque, and it is possible to use various kinds of resin films as the film support. Specific examples thereof may include various resin films such as of poly (meth)acrylic ester, polyethylene terephthalate (PET), polyethylene naphthalate (PEN), polycarbonate (PC), polyarylate, polystyrene (PS), aromatic polyamide, polyetheretherketone, polysulfone, polyethersulfone, polyimide, and polyetherimide, and further resin films formed by laminating two or more layers of the resin films as described above. Polyethylene terephthalate (PET), polyethylene naphthalate (PEN), polycarbonate (PC), or the like may be preferably used from the viewpoint of cost and easy availability.

A thickness of the light incoherent layer according to the present invention is not particularly limited, but the light incoherent layer preferably has an optical film thickness that is more than five times the optical film thickness of either one of the first reflective film and the second reflective film to be described later. The light incoherent layer is not involved in interference reflection of a thin film by having such an optical film thickness.

Moreover, in the light incoherent layer according to the present invention, a transmittance of visible light region indicated by JIS R3106: 1998 is preferably 85% or more and more preferably 90% or more. The transmittance is preferably in such a range since it is advantageous in order to attain a transmittance of the visible light region indicated by JIS R3106: 1998 of 30% or more when an infrared shielding body is formed.

The film support used in the light incoherent layer according to the present invention can be manufactured by a general method well-known in the related art. For example, a resin as a material is melted by an extruder, and the melted resin is extruded through a circular die or a T-die and cooled rapidly, whereby it is possible to manufacture an unstretched substrate which is substantially amorphous and unoriented. In addition, it is possible to manufacture a stretched support by stretching an unstretched substrate in the flow (vertical axis) direction of the substrate or the perpendicular (horizontal axis) direction to the flow direction of the substrate by a well-known method such as uniaxial stretching, tenter type sequential biaxial stretching, tenter type simultaneous biaxial stretching, and tubular type simultaneous biaxial stretching. A stretch ratio in this case can be appropriately selected depending on the resin as the raw material of the substrate, and is preferably 2 to 10 times in each of the vertical axis direction and the horizontal axis direction.

As described above, the film support may be an unstretched film or a stretched film but is preferably a stretched film from the viewpoint of strength improvement, suppression of thermal expansion, or the like.

In addition, the film support according to the present invention may be subjected to relaxation treatment or off-line heat treatment in terms of dimensional stability. The relaxation treatment is preferably performed in the tenter during the horizontal stretching, or in the process to winding after leaving the tenter, after the heat setting during the stretching and film formation process of the polyester film. The relaxation treatment is performed at a treatment temperature of preferably from 80 to 200° C. and more preferably from 100 to 180° C. In addition, the relaxation treatment is performed at a relaxation rate in the range of 0.1 to 10% and more preferably from 2 to 6% in both the longitudinal direction and the lateral direction. The heat resistance of the support subjected to the relaxation treatment can be improved and further the dimensional stability thereof becomes favorable by performing the off-line heat treatment.

The film support according to the present invention is preferably coated with an undercoat layer coating liquid on one or both surfaces on an in-line mode in the film formation process. In the present invention, undercoat coating during the film formation process is referred to as in-line undercoat. Examples of resin used for the undercoat layer coating liquid useful in the present invention may include polyester resins, acrylic-modified polyester resins, polyurethane resins, acrylic resins, vinyl resins, vinylidene chloride resins, polyethyleneimine vinylidene resins, polyethyleneimine resins, polyvinyl alcohol resins, modified polyvinyl alcohol resins, and gelatin, or the like. These can be used singly or by mixing two or more kinds thereof. It is also possible to add an additive well-known in the related art to the undercoat layer. The undercoat layer can be formed by a well-known coating method such as roll coating, gravure coating, knife coating, dip coating, or spray coating. A coating amount of the undercoat layer is preferably about from 0.01 to 2 g/m² (dry state).

[First Reflective Film and Second Reflective Film]

The infrared shielding body of the present invention includes a first reflective film and a second reflective film, and the first reflective film and the second reflective film contain a polymer and metal-containing particles.

The constituent materials of the first reflective film and the second reflective film may be the same as or different from each other. In addition, the first reflective film and the second reflective film may have a single layer structure or a laminated structure having two or more layers. When the reflective film according to the present invention is a dielectric multilayer film, the first reflective film and the second reflective film have preferably a laminated structure having nine or more layers and more preferably a laminated structure having 15 or more layers from the viewpoint of increasing the reflectivity. In addition, the number of layers or a thickness of each layer of the first reflective film and the second reflective film may be different from each other, but it is preferable that the number of layers be the same or the film thickness be approximately the same. In addition, the number of layers of the first reflective film and the second reflective film is preferably 100 layers or less and even more preferably 50 layers or less. The manufacturing process is significantly simple and it is favorable from the viewpoint of productivity when the number of layers is in such a range.

Moreover, the first reflective film and the second reflective film are preferably an alternately laminated body of a high refractive index layer and a low refractive index layer when the first reflective film and the second reflective film have a laminated structure. It is possible to further increase infrared reflectivity of the infrared shielding body of the present invention by having such a constitution.

A refractive index of the high refractive index layer is preferably from 1.60 to 2.40 and more preferably from 1.65 to 2.10. In addition, a refractive index of the low refractive index layer is preferably from 1.30 to 1.50 and more preferably from 1.34 to 1.50.

In the first reflective film and the second reflective film, it is preferable to design a refractive index difference between the high refractive index layer and the low refractive index layer to be great from the viewpoint that a higher infrared reflectivity can be attained with a small number of layers, and the refractive index difference between the high refractive index layer and the low refractive index layer adjacent to each other is preferably 0.1 or more, more preferably 0.3 or more, and even more preferably 0.4 or more.

In addition, in the present invention, the refractive index difference between the high refractive index layer and the low refractive index layer adjacent to each other in the first reflective film and the second reflective film is preferably 0.1 or more, and it is preferable that all of the refractive index layers satisfy the range defined in the present invention when a plurality of the high refractive index layers and the low refractive index layers are included in the film. However, an outermost layer or an undermost layer may have a constitution out of the range defined in the present invention.

A reflectivity in a specific wavelength region is determined by refractive index difference of the adjacent two layers (high refractive index layer and low refractive index layer) and the number of laminated layers, and the same reflectivity is obtained with a smaller number of layers as the refractive index difference is greater. It is possible to calculate the refractive index difference and the number of layers required using a commercially available optical design software. For example, it is required to laminate more than 100 layers in order to obtain an infrared shield factor of 90% or more when the refractive index difference is less than 0.1, and thus not only the productivity would decrease but also scattering at the interface between the laminated layers would increase, which would lead deterioration in transparency. There is no upper limit to the refractive index difference from the viewpoint of improving the reflectivity and decreasing the number of layers.

The refractive index difference is determined by measuring refractive indices of a high refractive index layer and a low refractive index layer according to the following method and calculating a difference between the two which is denoted as the refractive index difference.

Each of the refractive index layers is fabricated as a single layer optionally using a substrate. The sample is cut into 10 cm×10 cm, and then the refractive index thereof is determined according to the following method. The surface on the side opposite (back surface) to the measurement surface of each sample is roughened, light absorption treatment of the back surface is performed with a black spray to prevent reflection of light on the back surface, and the reflectivity of the visible light region (400 nm to 700 nm) is measured at 25 points using U-4000 model (manufactured by Hitachi, Ltd.) as a spectrophotometer under the condition of 5 degree specular reflection and an average value of the measured values is determined, and the average refractive index is determined from the measured results.

Meanwhile, as used herein, the terms “high refractive index layer” and “low refractive index layer” mean that a refractive index layer having a higher refractive index is denoted as the high refractive index layer and a refractive index layer having a lower refractive index is denoted as the low refractive index layer when the refractive index difference between the two adjacent layers is compared. Hence, the terms “high refractive index layer” and “low-refractive index layer” include any form other than the form in which the respective refractive index layers have the same refractive index when attention is paid on the adjacent two refractive index layers in the respective refractive index layers constituting the optical reflective film.

(Polymer)

The polymer contained in the first reflective film and the second reflective film is not particularly limited. For example, it is possible to use a polymer described in JP-T-2002-509279 as the polymer. Specific examples thereof may include polyethylene naphthalate (PEN) and an isomers thereof (for example, 2,6-, 1,4-, 1,5-, 2,7- and 2,3-PEN), polyalkylene terephthalate (for example, polyethylene terephthalate (PET), polybutylene terephthalate and poly-1,4-cyclohexanedimethylene terephthalate), polyimide (for example, polyacrylimide), polyetherimide, atactic polystyrene, polycarbonate, polymethacrylate (for example, polyisobutyl methacrylate, polypropyl methacrylate, polyethyl methacrylate, and polymethyl methacrylate (PMMA)), polyacrylate (for example, polybutyl acrylate and polymethyl acrylate), cellulose derivatives (for example, ethyl cellulose, acetyl cellulose, cellulose propionate, acetyl cellulose butyrate, and cellulose nitrate), polyalkylene polymers (for example, polyethylene, polypropylene, polybutylene, polyisobutylene, and poly(4-methyl)pentene), fluorinated polymers (for example, perfluoroalkoxy resins, polytetrafluoroethylene, fluorinated ethylene propylene copolymers, polyvinylidene fluoride, and polychlorotrifluoroethylene), chlorinated polymers (for example, polyvinylidene chloride and polyvinyl chloride), polysulfone, polyethersulfone, polyacrylonitrile, polyamide, silicone resins, epoxy resins, polyvinyl acetate, polyether amide, ionomer resins, elastomers (for example, polybutadiene, polyisoprene and neoprene), and polyurethane. Copolymers, for example, copolymers of PEN [for example, copolymers of (a) terephthalic acid or an ester thereof, (b) isophthalic acid or an ester thereof, (c) phthalic acid or an ester thereof, (d) alkane glycol, (e) cycloalkane glycol (for example, cyclohexane dimethanol diol), (f) alkane dicarboxylic acid, and/or (g) cycloalkanedicarboxylic acid (for example, cyclohexanedicarboxylic acid) with 2,6-, 1,4-, 1,5-, 2,7- and/or 2,3-naphthalenedicarboxylic acid or an ester thereof], copolymers of polyalkylene terephthalate [for example, copolymers of (a) naphthalenedicarboxylic acid or an ester thereof, (b) isophthalic acid or an ester thereof, (c) phthalic acid or an ester thereof, (d) alkane glycol, (e) cycloalkane glycol (for example, cyclohexane dimethanol diol), (f) alkane dicarboxylic acid, and/or (g) cycloalkanedicarboxylic acid (for example, cyclohexanedicarboxylic acid) with terephthalic acid or an ester thereof], styrene copolymers (for example, styrene-butadiene copolymers and styrene-acrylonitrile copolymers), 4,4-bis-benzoic acid, and ethylene glycol are also suitable. Moreover, each of the layers may contain a blend (for example, a blend of syndiotactic polystyrene (SPS) and atactic polystyrene) of two or more kinds of the polymers or copolymers.

In addition, it is also preferable to use a water-soluble polymer as the polymer. The water-soluble polymer is preferable since an organic solvent is not used therein and thus the water-soluble polymer has low environmental load, and the water-soluble polymer exhibits high flexibility and thus the durability of the film at the time of bending is improved. Examples of the water-soluble polymer may include synthetic water-soluble polymers such as polyvinyl alcohols, polyvinyl pyrrolidone, polyvinyl butyral, acrylic resins such as polyacrylic acid, acrylic acid-acrylonitrile copolymer, potassium acrylate-acrylonitrile copolymer, vinyl acetate-acrylic acid ester copolymer, or acrylic acid-acrylic acid ester copolymer, styrene-acrylic acid resins such as styrene-acrylic acid copolymer, styrene-methacrylic acid copolymer, styrene-methacrylic acid-acrylic acid ester copolymer, styrene-α-methyl styrene-acrylic acid copolymer, or styrene-α-methyl styrene-acrylic acid-acrylic acid ester copolymer, and vinyl acetate-based copolymers such as styrene-sodium styrene sulfonate copolymer, styrene-2-hydroxyethyl acrylate copolymer, styrene-2-hydroxyethyl acrylate-potassium styrene sulfonate copolymer, styrene-maleic acid copolymer, styrene-maleic anhydride copolymer, vinyl naphthalene-acrylic acid copolymer, vinyl naphthalene-maleic acid copolymer, vinyl acetate-maleic acid ester copolymer, vinyl acetate-crotonic acid copolymer, or a vinyl acetate-acrylic acid copolymer or the salts thereof; and natural water-soluble polymers such as gelatin and polysaccharide thickeners. Among these, particularly preferred examples may include polyvinyl alcohols, polyvinyl pyrrolidones and copolymer containing the same, polyvinyl butyral, gelatin, and polysaccharide thickeners (particularly cellulose) from the viewpoint of handling at the time of manufacturing and flexibility of film. These water-soluble polymers may be used singly or two or more kinds thereof may be used concurrently.

Examples of the polyvinyl alcohol preferably used in the present invention may include modified polyvinyl alcohols in addition to usual polyvinyl alcohols obtained by hydrolysis of polyvinyl acetate. Examples of the modified polyvinyl alcohol may include cation-modified polyvinyl alcohols, anion-modified polyvinyl alcohols, nonion-modified polyvinyl alcohols, and vinyl alcohol-based polymers.

As the polyvinyl alcohol obtained by hydrolysis of vinyl acetate, those having an average polymerization degree of 800 or more are preferably used and those having an average polymerization degree of from 1,000 to 5,000 are particularly preferably used. In addition, a saponification degree thereof is preferably from 70 to 100 mol % and particularly preferably from 80 to 99.5 mol %.

The cation-modified polyvinyl alcohol includes, for example, polyvinyl alcohol having a primary to tertiary amino group or a quaternary ammonium group in the main chain or side chain of the polyvinyl alcohol as described in JP-A-61-10483, and the cation-modified polyvinyl alcohol is obtained by saponifying a copolymer of an ethylenically unsaturated monomer having a cationic group and vinyl acetate.

Examples of the ethylenically unsaturated monomer having a cationic group may include trimethyl-(2-acrylamido-2,2-dimethylethyl)ammonium chloride, trimethyl-(3-acrylamide-3,3-dimethylpropyl)ammonium chloride, N-vinylimidazole, N-vinyl-2-methylimidazole, N-(3-dimethylaminopropyl)methacrylamide, hydroxyethyltrimethylammonium chloride, trimethyl-(2-methacrylamidopropyl)ammonium chloride, and N-(1,1-dimethyl-3-dimethylaminopropyl)acrylamide, or the like. A ratio of the cation-modified group containing monomer of the cation-modified polyvinyl alcohol is preferably from 0.1 to 10 mol % and more preferably from 0.2 to 5 mol %, relative to vinyl acetate.

Examples of the anion-modified polyvinyl alcohol may include polyvinyl alcohol having an anionic group as described in JP-A-1-206088, copolymers of vinyl alcohol and a vinyl compound having a water-soluble group as described in JP-A-61-237681 and JP-A-63-307979, and modified polyvinyl alcohols having a water-soluble group as described in JP-A-7-285265.

In addition, examples of the nonion-modified polyvinyl alcohol may include polyvinyl alcohol derivatives obtained by adding a polyalkylene oxide group to a part of vinyl alcohol as described in JP-A-7-9758, block copolymers of a vinyl compound having a hydrophobic group and vinyl alcohol as described in JP-A-8-25795, silanol-modified polyvinyl alcohols having a silanol group, and reactive group-modified polyvinyl alcohols having a reactive group such as an acetoacetyl group, a carbonyl group, or a carboxyl group. In addition, examples of the vinyl alcohol-based polymer may include EXCEVAL (registered trademark, manufactured by KURARAY CO., LTD.) or Nichigo G Polymer (trade name, manufactured by The Nippon Synthetic Chemical Industry Co., Ltd.). It is also possible to concurrently use two or more kinds of polyvinyl alcohols having different degrees of polymerization or different kinds of modification.

In the present invention, the first reflective film and the second reflective film preferably contain two or more kinds of polyvinyl alcohols having saponification degrees different from one another when they have a laminated structure having two or more layers. Here, in order to distinguish the polyvinyl alcohols, the polyvinyl alcohol contained in the layer (A) of the first reflective film is referred to as the polyvinyl alcohol (a), and the polyvinyl alcohol contained in the layer (B) of the first reflective film is referred to as the polyvinyl alcohol (b). Similarly, the polyvinyl alcohol contained in the layer (C) of the second reflective film is referred to as the polyvinyl alcohol (c), and the polyvinyl alcohol contained in the layer (D) of the second reflective film is referred to as the polyvinyl alcohol (d).

Meanwhile, when each of the layers contains a plurality of polyvinyl alcohols having different saponification degrees and different polymerization degrees from one another, the polyvinyl alcohol having the highest content in each of the layers is referred to as the polyvinyl alcohol (a) in the layer (A), the polyvinyl alcohol (b) in the layer (B), the polyvinyl alcohol (c) in the layer (C), and the polyvinyl alcohol (d) in the layer (D), respectively.

As described above, the first reflective film and the second reflective film are preferably an alternately laminated body of a high refractive index layer and a low refractive index layer, and in the first reflective film, the low refractive index layer preferably contains polyvinyl alcohol (a) and silicon oxide, and the high refractive index layer preferably contains polyvinyl alcohol (b) having a saponification degree different from that of the polyvinyl alcohol (a) and titanium oxide particles, from the viewpoint of further enhancing infrared reflectivity. In other words, the first reflective film is an alternately laminated body of a layer (A) containing at least polyvinyl alcohol (a) and silicon oxide particles and a layer (B) containing at least polyvinyl alcohol (b) having a saponification degree different from that of the polyvinyl alcohol (a) and titanium oxide particles. Similarly, in the second reflective film, the low refractive index layer preferably contains polyvinyl alcohol (c) and silicon oxide, and the high refractive index layer preferably contains polyvinyl alcohol (d) having a saponification degree different from that of the polyvinyl alcohol (c) and titanium oxide particles. In other words, the second reflective film is preferably an alternately laminated body of a layer (C) containing at least polyvinyl alcohol (c) and silicon oxide particles and a layer (D) containing at least polyvinyl alcohol (d) having a saponification degree different from that of the polyvinyl alcohol (c) and titanium oxide particles.

Hereinafter, the polyvinyl alcohol (a) and the polyvinyl alcohol (b) used in the first reflective film will be described. Meanwhile, the polyvinyl alcohol (c) used in the second reflective film has the same constitution as the polyvinyl alcohol (a) and the polyvinyl alcohol (d) used in the second reflective film has the same constitution as the polyvinyl alcohol (b), and thus the description thereof will be omitted herein.

The term “saponification degree” used herein refers to a proportion of the number of hydroxyl groups relative to the total number of acetyloxy groups (derived from vinyl acetate as the raw material) and hydroxyl groups in the polyvinyl alcohol.

When the expression “polyvinyl alcohol having the highest content in the layer” as referred to herein is used, the polymerization degree is calculated by taking the polyvinyl alcohols having a difference in saponification degree of 3 mol % or less as the same polyvinyl alcohol. However, polyvinyl alcohols having a low polymerization degree of 1000 or less are taken as different polyvinyl alcohols (the polyvinyl alcohols are not taken as the same polyvinyl alcohol even if the difference in saponification degree thereof is 3 mol % or less). Specifically, when polyvinyl alcohols having a saponification degree of 90 mol %, 91 mol %, and 93 mol % are contained in the same layer at 10 mass %, 40 mass %, and 50 mass %, respectively, these three polyvinyl alcohols are taken as the same polyvinyl alcohol and a mixture of these three is taken as the polyvinyl alcohol (a) or (b). In addition, the expression “polyvinyl alcohols having a difference in saponification degree of 3 mol % or less” is satisfied when the difference in saponification degree is 3 mol % or less in the case of taking any of the polyvinyl alcohols as a basis, and for example, in the case of containing polyvinyl alcohols of 90 mol %, 91 mol %, 92 mol %, and 94 mol %, the difference in saponification degree in any of the other polyvinyl alcohols is 3 mol % or less when the polyvinyl alcohol of 91 mol % is taken as the basis, and thus these polyvinyl alcohols is regarded as the same polyvinyl alcohol.

When polyvinyl alcohols having saponification degrees different by 3 mol % or more from one another are contained in the same layer, the polyvinyl alcohols are regarded as a mixture of different polyvinyl alcohols and the polymerization degree and the saponification degree are respectively calculated. For example, when PVA203, PVA117, PVA217, PVA220, PVA224, PVA235, and PVA245 are contained at 5 mass %, 25 mass %, 10 mass %, 10 mass %, 10 mass %, 20 mass %, and 20 mass %, respectively, the PVA (polyvinyl alcohol) having the highest content is a mixture of PVA217 to PVA245 (PVA217 to PVA245 are the same polyvinyl alcohol since they have a difference in saponification degree of 3 mol % or less) and thus this mixture is the polyvinyl alcohol (a) or (b). Incidentally, the polymerization degree of the mixture of PVA217 to PVA245 (polyvinyl alcohol (a) or (b)) is (1700×0.1+2000×0.1+2400×0.1+3500×0.2+4500×0.7)/0.7=3200 and the saponification degree thereof is 88 mol %.

The difference in the absolute values of the saponification degrees of the polyvinyl alcohol (a) and the polyvinyl alcohol (b) is preferably 3 mol % or more and more preferably 5 mol % or more. It is preferable to have the difference in such a range since an interlayer mixed state between a high refractive index layer and a low refractive index layer is at a preferred level. In addition, the difference in saponification degrees of the polyvinyl alcohol (a) and the polyvinyl alcohol (b) is preferably as great as possible but is preferably 20 mol % or less from the viewpoint of solubility of the polyvinyl alcohol in water.

The saponification degrees of the polyvinyl alcohol (a) and the polyvinyl alcohol (b) are preferably 75 mol % or more from the viewpoint of solubility in water, respectively. Moreover, it is preferable that one of the polyvinyl alcohol (a) and the polyvinyl alcohol (b) has a saponification degree of 90 mol % or more and the other has a saponification degree of 90 mol % or less in order to have an interlayer mixed state between a high refractive index layer and a low refractive index layer at a preferred level. It is more preferable that one of the polyvinyl alcohol (a) and the polyvinyl alcohol (b) has a saponification degree of 95 mol % or more and the other has a saponification degree of 90 mol % or less. Meanwhile, the upper limit of the saponification degree of the polyvinyl alcohol is not particularly limited but is usually less than 100 mol % and is about 99.9 mol % or less.

The polymerization degree of two kinds of polyvinyl alcohols having different saponification degrees from each other is preferably 1,000 or more, more preferably 1,500 to 5,000, and even more preferably 2,000 to 5,000. When the polymerization degree of the polyvinyl alcohol is 1,000 or more, cracking of a coating film would not occur. And when the polymerization degree of the polyvinyl alcohol is 5,000 or less, the coating liquid would be stable. Meanwhile, the expression “coating liquid is stable” as used in the present specification means that the coating liquid is stable over time. The polymerization degree of at least one of the polyvinyl alcohol (a) and the polyvinyl alcohol (b) is preferably 2,000 to 5,000, since cracking of a coating film would be reduced and reflectivity of a specific wavelength would be improved. The polymerization degree of both of the polyvinyl alcohol (a) and the polyvinyl alcohol (b) is preferably 2,000 to 5,000, since the effects above can be exerted more remarkably.

The “polymerization degree” as used in the present specification refers to a viscosity average polymerization degree, is measured in accordance with JIS K6726:1994, and is determined by the following Equation from a limiting viscosity [η] (dl/g) measured in water at 30° C. after PVA is completely resaponified and purified.

P=([η]×10³/8.29)^{(1/0.62)} [Equation 1]

As the polyvinyl alcohols (a) and (b) used in the present invention, a synthetic product or a commercially available product may be used. Examples of the commercially available product usable as the polyvinyl alcohols (a) and (b) may include PVA-102, PVA-103, PVA-105, PVA-110, PVA-117, PVA-120, PVA-124, PVA-203, PVA-205, PVA-210, PVA-217, PVA-220, PVA-224, PVA-235, and R-1130 (POVAL (registered trademark) series manufactured by KURARAY CO., LTD.), RS-2117 (EXCEVAL (registered trademark) series manufactured by KURARAY CO., LTD.), and JC-25, JC-33, JF-03, JF-04, JF-05, JF-17, JP-03, JP-04, JP-05, and JP-45 (manufactured by JAPAN VAM & POVAL CO., LTD.), or the like.

For example, when polyvinyl alcohol (a) having a low saponification degree is used in a low refractive index layer and polyvinyl alcohol (b) having a high saponification degree is used in a high refractive index layer, the polyvinyl alcohol (a) in the low refractive index layer is contained in an amount in the range of preferably 40 mass % or more and 100 mass % or less and more preferably 60 mass % or more and 95 mass % or less with respect to a total mass of all polyvinyl alcohols in the low refractive index layer, and the polyvinyl alcohol (b) in the high refractive index layer is contained in an amount in the range of preferably 40 mass % or more and 100 mass % or less and more preferably 60 mass % or more and 95 mass % or less with respect to a total mass of all polyvinyl alcohols in the high refractive index layer. In addition, when polyvinyl alcohol (a) having a high saponification degree is used in a low refractive index layer and polyvinyl alcohol (b) having a low saponification degree is used in a high refractive index layer, the polyvinyl alcohol (a) in the low refractive index layer is contained in an amount in the range of preferably 40 mass % or more and 100 mass % or less and more preferably 60 mass % or more and 95 mass % or less with respect to a total mass of all polyvinyl alcohols in the low refractive index layer, and the polyvinyl alcohol (b) in the high refractive index layer is contained in an amount in the range of preferably 40 mass % or more and 100 mass % or less and more preferably 60 mass % or more and 95 mass % or less with respect to a total mass of all polyvinyl alcohols in the high refractive index layer. When the content is 40 mass % or more, the effects that interlayer mixing is suppressed and turbulence of the interface is reduced can be exerted remarkably. On the other hand, when the content is 100% by mass or less, stability of a coating liquid can be improved.

The saponification degree of the polyvinyl alcohol (a) used in the first reflective film may be the same as or different from that of the polyvinyl alcohol (c) used in the second reflective film. Similarly, the saponification degree of the polyvinyl alcohol (b) used in the first reflective film may be the same as or different from that of the polyvinyl alcohol (d) used in the second reflective film.

As gelatin used in the present invention, an acid-treated gelatin may be used in addition to lime-treated gelatin, furthermore it is also possible to use a hydrolysate of gelatin and an enzymatically decomposed gelatin.

Examples of polysaccharide thickener used in the present invention may include generally known natural simple polysaccharides, natural complex polysaccharides, synthetic simple polysaccharides, and synthetic complex polysaccharides. It is possible to see “Biochemistry Dictionary (2nd Edition), Tokyo Kagaku Dojin Publishing”, “Food Industry” Volume 31 (1988), page 21, or the like for the details on these polysaccharides.

The polysaccharide thickener referred to in the present invention is a polysaccharide which is a polymer of saccharide, has a large number of hydrogen bonding groups in the molecule, is equipped with a characteristic that the difference between viscosity at a low temperature and viscosity at a high temperature is great due to the difference in hydrogen bonding force between the molecules depending on the temperature, and furthermore causes an increase in viscosity considered to be due to hydrogen bonding with a metal oxide fine particles at a low temperature when the metal oxide fine particles are added thereto. The viscosity increase of the polysaccharide caused by the addition of the metal oxide fine particles at 40° C. is preferably 1.0 mPa·s or more, more preferably 5.0 mPa·s or more, and polysaccharide having ability to cause the increase in viscosity of 10.0 mPa·s or more is used even more preferably.

Examples of the polysaccharide thickener applicable to the present invention may include β1-4 glucan (for example, carboxymethyl cellulose, carboxyethyl cellulose, or the like), galactan (for example, agarose, agaropectin, or the like), galactomannoglycan (for example, locust bean gum, guaran, or the like), xyloglucan (for example, tamarind gum, or the like), glucomannoglycan (for example, konjac mannan, wood-derived glucomannan, xanthan gum, or the like), galactoglucomannoglycan (for example, a softwood-derived glycan), arabinogalactoglycan (for example, a soybean-derived glycan, a microbial-derived glycan, or the like), glucorhamnoglycan (for example, gellan gum, or the like), glycosaminoglycan (for example, hyaluronic acid, keratan sulfate, or the like), alginic acid and alginate salts, natural macromolecular polysaccharides derived from red algae such as agar, κ-carrageenan, λ-carrageenan, τ-carrageenan, and furcellaran. Particularly when metal oxide particles are contained as described below, the polysaccharide thickener has preferably a constituent unit having no carboxyl or sulfoxyl groups from the viewpoint of preventing decrease in dispersion stability of the metal oxide fine particles. Preferred examples of such a polysaccharide may include a polysaccharide composed of only pentose such as L-arabinose, D-ribose, 2-deoxyribose, and D-xylose, hexose such as D-glucose, D-fructose, D-mannose, or D-galactose. Specifically, tamarind seed gum known as xyloglucan having as a main chain glucose and as a side chain xylose, guar gum known as galactomannan having as a main chain mannose and as a side chain galactose, locust bean gum, tara gum, arabinogalactan having as a main chain galactose and as a side chain arabinose can be preferably used.

In the present invention, two or more kinds of polysaccharide thickeners may be used concurrently.

A weight average molecular weight of the water-soluble polymer is preferably from 1,000 to 200,000 and more preferably from 3,000 to 40,000. Meanwhile, in the present specification, the weight average molecular weight is a value measured by gel permeation chromatography (GPC) under measurement conditions shown in the following Table 1.

TABLE 1
Solvent: 0.2M NaNO₃, NaH₂PO₄, pH 7
Column: combination of Shodex Column Ohpak SB-802.5 HQ, 8 × 300
mm and Shodex Column Ohpak SB-805 HQ, 8 × 300 mm
Column temperature: 45° C.
Sample concentration: 0.1 mass %
Detector: RID-10A (manufactured by Shimadzu Corporation)
Pump: LC-20AD (manufactured by Shimadzu Corporation)
Flow rate: 1 ml/min
Calibration curve: a calibration curve created using
Standard P-82 standard material pullulan for Shodex
Standard GFC (aqueous GPC) column is used

A curing agent may be used in order to cure the water-soluble polymer in the case of using a water-soluble polymer as the polymer.

The curing agent applicable to the present invention is not particularly limited as long as a curing agent causes curing reaction with the water-soluble polymer, but boric acid or the salt thereof is preferable when the water-soluble polymer is polyvinyl alcohol. A well-known curing agent can also be used in addition thereto. In general, a compound having a group capable of reacting with the water-soluble polymer or a compound capable of promoting the reaction of different groups contained in the water-soluble polymer may be used, and a curing agent can be appropriately selected and used depending on the kind of the water-soluble polymer. Specific examples of the curing agent other than boric acid and the salt thereof may include epoxy-based curing agents (diglycidyl ethyl ether, ethylene glycol diglycidyl ether, 1,4-butanediol diglycidyl ether, 1,6-diglycidyl cyclohexane, N,N-diglycidyl-4-glycidyloxyaniline, sorbitol polyglycidyl ether, glycerol polyglycidyl ether, or the like), aldehyde-based curing agents (formaldehyde, glyoxal or the like), active halogen-based curing agents (2,4-dichloro-4-hydroxy-1,3,5-s-triazine or the like), active vinyl-based compounds (1,3,5-tris-acryloyl-hexahydro-s-triazine, bisvinylsulfonylmethylether, or the like), and aluminum alum, or the like.

When the water-soluble polymer is gelatin, organic hardening agents such as vinyl sulfone compounds, urea-formaldehyde condensates, melamine-formaldehyde condensates, epoxy-based compounds, aziridine-based compounds, active olefins, and isocyanate-based compounds and inorganic polyvalent metal salts of chromium, aluminum, zirconium or the like may be cited.

Meanwhile, when the polymer is a copolymer, the form of the copolymer may be any of a block copolymer, a random copolymer, a graft copolymer, and an alternating copolymer.

(Metal-Containing Particles)

The first reflective film and the second reflective film according to the present invention contain metal-containing particles. The material of the metal-containing particles is not particularly limited, and examples thereof may include elemental metals such as gold, silver, copper, aluminum, gallium, indium, zinc, rhodium, palladium, iridium, nickel, platinum, manganese, iron, zirconium, molybdenum, chromium, tungsten, tin, germanium, lead, and antimony, or alloys of these metals. In addition, metal oxides such as titanium oxide, zirconium oxide, tantalum pentoxide, zinc oxide, silicon oxide (synthetic amorphous silica, colloidal silica, or the like), alumina, colloidal alumina, lead titanate, red lead, chrome yellow, zinc yellow, chromium oxide, ferric oxide, iron black, copper oxide, magnesium oxide, magnesium hydroxide, magnesium fluoride, strontium titanate, yttrium oxide, niobium oxide, europium oxide, lanthanum oxide, zircon, or tin oxide can be suitably used.

Among these, particles of elemental metal or metal oxide particles are preferable. Moreover, the particles of elemental metal preferably have a tabular shape.

Hereinafter, tabular metal particles and metal oxide particles which are preferred examples of the metal-containing particles will be described in detail.

(Tabular Metal Particles)

The tabular metal particles are not particularly limited as long as the particles have two principal planes, and can be appropriately selected according to the purpose. Examples of the shape when observed from the upper of the main plane may include a substantially hexagonal shape, a substantially disc shape, and a substantially triangular shape. Among these, a substantially hexagonal shape and a substantially disc shape are preferable in terms of high visible light transmittance.

The substantially hexagonal shape is not particularly limited as long as the tabular metal particles have a substantially hexagonal shape when observed from the upper of the main plane by a transmission electron microscope (TEM), and can be appropriately selected according to the purpose. For example, an angle of the hexagonal shape may be an acute angle or an obtuse angle, but the angle is preferably an obtuse angle from the viewpoint that absorption in visible light region can be reduced. A degree of dullness of the angle is not particularly limited, and can be appropriately selected.

The substantially disc shape is not particularly limited as long as the tabular metal particles does not have an angle but have a round shape when observed from the upper of the main plane by a transmission electron microscope (TEM), and can be appropriately selected.

A proportion of the tabular metal particles having substantially hexagonal shape or a substantially disk shape is preferably 60% by number or more, more preferably 65% by number or more, and even more preferably 70% by number or more, relative to the total number of tabular metal particles. When the proportion of the tabular metal particles is in the range, visible light transmittance can be improved.

An average particle size of the tabular metal particles is not particularly limited and can be appropriately selected. The average particle size is preferably from 70 nm to 500 nm and more preferably from 100 nm to 400 nm. When the average particle size is in the range, infrared reflecting ability can be sufficiently obtained, haze can be reduced, and transparency can be improved. Meanwhile, the average particle size means an average of the diameters of main plane (maximum length) of the 200 tabular particles which are arbitrarily selected from an image obtained by observing the particles by TEM.

An aspect ratio of the tabular metal particles is not particularly limited and can be appropriately selected according to the purpose. The aspect ratio is preferably 2 or more, more preferably from 2 to 30, and even more preferably from 4 to 25, from the viewpoint that reflectivity from long wavelength side in a visible light region to near infrared region increases. When the aspect ratio is in the range, infrared reflectivity can increase and haze can be reduced. Meanwhile, the aspect ratio means a value (L/d) obtained by dividing an average particle size (average equivalent circle diameter) (L) of the tabular metal particles by an average particle thickness (d) of the tabular metal particles (see FIG. 1A and FIG. 1B). The average particle thickness corresponds to a distance between the main planes of the tabular metal particles and can be measured by, for example, an atomic force microscope (AFM).

A method of measuring the average particle thickness by AFM is not particularly limited and can be appropriately selected. Examples thereof may include a method which comprises dropping a particle dispersion containing tabular metal particles on a glass substrate, drying, and then measuring a thickness of one tabular metal particle.

(Manufacturing Method of Tabular Metal Particles)

Examples of a manufacturing method of the tabular metal particles may include liquid phase methods such as a chemical reduction method, a photochemical reduction method, or an electrochemical reduction method. Among these, a chemical reduction method, a photochemical reduction method, or the like is preferable from the viewpoint of controllability of shape and size. It is also possible to obtain tabular metal particles having a substantially hexagonal shape or a substantially disk shape by synthesizing tabular metal particles having a hexagonal shape or a triangular shape and then performing an etching process by a dissolving species, such as nitric acid, sodium sulfite, a halogen ion such as Br⁻ or Cl⁻, which dissolves silver or an aging process by heating so as to blunt an angle of the tabular metal particles having a hexagonal shape or a triangular shape.

Meanwhile, the manufacturing method of the tabular metal particles above may be a method which comprises fixing a seed crystal on a surface of a transparent substrate such as film or glass in advance and then performing crystal growth of metal particles (for example, Ag) in a tabular shape, as well as the method above.

The tabular metal particles may be subjected to an additional process in order to be imparted with desired properties. Such a process is not particularly limited and examples thereof may include formation of a high refractive index shell layer or addition of various kinds of additives such as a dispersant and an antioxidant.

The tabular metal particles may be covered with a high refractive index material exhibiting high transparency in a visible light region in order to enhance visible region transparency.

The high refractive index material is not particularly limited and examples thereof may include TiOₓ, BaTiO₃, ZnO, SnO₂, ZrO₂, and NbOₓ.

The covering method is not particularly limited and, for example, may be a method of forming a TiOₓ layer on a surface of tabular metal particles by hydrolyzing tetrabutoxytitanium as reported in Langmuir, 2000, Vol. 16, p. 2731-2735.

When it is difficult to form a high refractive index shell layer directly on tabular metal particles, it is also possible to synthesize the tabular metal particles as described above, to form appropriately a shell layer of SiO₂ or a polymer, and then to form a metal oxide layer on the shell layer. In the case of using TiOₓ as a material of a high refractive index shell layer, a SiO₂ layer may be appropriately formed after forming a TiOₓ layer on the tabular metal particles according to the purpose, since TiOₓ has a photocatalytic activity and thus there is a concern that TiOₓ degrades a matrix for dispersing the tabular metal particles.

An antioxidant such as mercaptotetrazole or ascorbic acid may be adsorbed to the tabular metal particles in order to suppress oxidation of a metal such as silver constituting the tabular metal particles. In addition, a sacrificial oxidation layer such as Ni may be formed on the surface of the tabular metal particles for the purpose of preventing oxidation. Moreover, the tabular metal particles may be covered with a metal oxide film such as SiO₂ for the purpose of suppressing permeation of oxygen.

It is also possible to add a dispersant such as a low molecular weight dispersant containing an N element, an S element, or a P element, for example, a quaternary ammonium salt or an amine or a high molecular weight dispersant, to the tabular metal particles for the purpose of imparting dispersibility.

The tabular metal particles may be plane-oriented. As a method of plane orientating the tabular metal particles, a method of plane orientating by using electrostatic interaction may be employed in order to increase adsorptivity of the tabular metal particles to a substrate and plane orientation thereof. Specifically, when a surface of the tabular metal particles is negatively charged (for example, in a state of being dispersed in a negatively charged medium such as citric acid), a method which comprises positively charging a surface of the substrate in advance (for example, modifying the surface of the substrate with an amino group) and electrostatically increasing plane orientation, thereby attaining plane orientation of the tabular metal particles. In addition, when a surface of the tabular metal particles is hydrophilic, the surface of the substrate may be formed into a hydrophilic and hydrophobic sea-island structure by a block copolymer or a microcontact stamping method in advance, to control plane orientation and interparticle distance of the tabular metal particles by means of hydrophilic and hydrophobic interaction.

(Metal Oxide Particles)

It is preferable to incorporfate metal oxide particles in the first reflective film and the second reflective film, in terms that refractive index difference between refractive index layers can be increased and transparency of the film can be improved. Moreover, there are advantages that stress relaxation functions, to improve film properties (flexibility at the time of bending and at a high temperature and high humidity), or the like. In the case of using metal oxide particles, the metal oxide particles may be contained in any layer constituting the first reflective film or the second reflective film. In a preferred embodiment, the metal oxide particles are contained in at least the high refractive index layer of either of the first reflective film or the second reflective film, and in a more preferred embodiment, the metal oxide particles are contained in both of the high refractive index layer and the low refractive index layer of either of the first reflective film or the second reflective film.

An average particle size of the metal oxide particles is preferably 100 nm or less, more preferably from 4 to 50 nm, and even more preferably from 5 to 40 nm. The average particle size of the metal oxide particles may be obtained by observing particles themselves or particles appearing on the cross section or surface of s layer by an electron microscope, measuring particle sizes of 1,000 arbitrary selected particles, and then determining a simple average value (number average) of the measured values. As used herein, a particle size of individual particles is represented by a diameter when a circle equal to a projected area thereof is assumed.

In the low refractive index layer, it is preferable to use silicon oxide (silica) as the metal oxide particles and it is more preferable to use an acid colloidal silica sol.

(Silicon Oxide)

Preferred examples of silicon oxide (silica) usable in the present invention may include silica synthesized by a usual wet method, colloidal silica, or silica synthesized by a gas phase method. As the fine particle silica particularly preferably used in the present invention, colloidal silica or fine particle silica synthesized by a gas phase method may be exemplified.

The metal oxide particles are preferably in a state in which even the primary particles are dispersed in the fine particle dispersion before being mixed with a cationic polymer.

For example, in the case of the fine particle silica synthesized by a gas phase method, an average particle size (particle size in a dispersion state before coating) of the primary particles of the metal oxide fine particles dispersed in a state of primary particles is preferably 100 nm or less, more preferably from 4 to 50 nm, and even more preferably from 4 to 20 nm.

As silica which is even more preferably used, has an average particle size of primary particles of from 4 to 20 nm, and is synthesized by a gas phase method, for example, AEROSIL manufactured by Nippon Aerosil Co., Ltd. is commercially available. It is possible to relatively easily disperse the fine particle silica synthesized by a gas phase method in water in a primary particle state by easily suction dispersing the fine particle silica in water, for example, by a jet stream inductor mixer manufactured by Mitamura Riken Kogyo Co., Ltd. or the like.

Various AEROSIL products manufactured by Nippon Aerosil Co., Ltd. are commercially available at present as the silica synthesized by a gas phase method.

The colloidal silica preferably usable in the present invention can be obtained by heat aging silica sol obtained by double decomposing sodium silicate by an acid or the like or by being passed through a ion exchange resin layer.

A preferred average particle size of the colloidal silica is usually from 5 to 100 nm, more preferably from 7 to 30 nm.

A surface of the silica synthesized by a gas phase method and colloidal silica may be cationically modified or treated with Al, Ca, Mg, Ba, and the like.

As the metal oxide particles contained in a high refractive index layer, TiO₂, ZnO, and ZrO₂ are preferable and TiO₂ (titanium oxide sol) is more preferable from the viewpoint of stability of a metal oxide particle-containing composition for forming the high refractive index layer to be described below. In addition, a rutile type is more preferable than an anatase type among TiO₂ in terms that weather resistance of a high refractive index layer or the adjacent layer thereof can increase due to its low catalytic activity, and that a refractive index is high.

(Titanium Oxide)

Manufacturing method of titanium oxide sol The first step in the manufacturing method of the rutile-type fine particle titanium oxide is a step (step (1)) of treating a titanium oxide hydrate with at least one basic compound selected from the group consisting of hydroxides of alkali metal and hydroxides of alkaline earth metal.

The titanium oxide hydrate can be obtained by hydrolysis of a water-soluble titanium compound such as titanium sulfate or titanium chloride. The method of hydrolysis is not particularly limited, and a well-known method can be applied. Among them, titanium oxide hydrate obtained by thermal hydrolysis of titanium sulfate is preferable.

The step (1) can be performed, for example, by adding the basic compound to an aqueous suspension of the titanium oxide hydrate and treating (reacting) for a predetermined time at a predetermined temperature.

The method of preparing an aqueous suspension of the titanium oxide hydrate is not particularly limited, and the preparation can be performed by adding the titanium oxide hydrate in water and stirring the mixture. A concentration of the suspension is not particularly limited, but a concentration of TiO₂ in the suspension is preferably from 30 to 150 g/L. The reaction (treatment) can efficiently proceed by setting the concentration in the range described above.

The at least one basic compound selected from the group consisting of hydroxides of an alkali metal and hydroxides of an alkaline earth metal used in the step (1) above is not particularly limited. Examples thereof may include sodium hydroxide, potassium hydroxide, magnesium hydroxide, and calcium hydroxide, or the like. For an amount of the basic compound added in the step (1), a concentration of the basic compound in the reaction (treatment) suspension is preferably from 30 to 300 g/L.

The step (1) is preferably performed at a reaction (treatment) temperature of from 60 to 120° C. A reaction (treatment) time varies depending on the reaction (treatment) temperature, but is preferably from 2 to 10 hours. The reaction (treatment) is preferably performed by adding an aqueous solution of sodium hydroxide, potassium hydroxide, magnesium hydroxide or calcium hydroxide to a suspension of titanium oxide hydrate. After the reaction (treatment), the reaction (treatment) mixture is cooled, otionally neutralized with an inorganic acid such as hydrochloric acid, then filtered, and washed with water, to obtain titanium oxide hydrate fine particles.

In addition, as the second step (step (2)) the compound obtained by the step (1) may be treated with a carboxyl group-containing compound and an inorganic acid. In the production of rutile type titanium oxide fine particles, a method of treating the compound obtained by the step (1) with an inorganic acid is a well-known method, but a carboxyl group-containing compound may be used in addition to the inorganic acid to adjust a particle size.

The carboxyl group-containing compound is an organic compound having a —COOH group. The carboxyl group-containing compound is preferably polycarboxylic acid having preferably two or more carboxyl groups and more preferably two or more and four or less carboxyl groups. It is presumed that the aggregation of fine particles is inhibited by coordination of the polycarboxylic acid since the polycarboxylic acid has a property to coordinate a metal atom, and thus the rutile type titanium oxide fine particles can be suitably obtained.

The carboxyl group-containing compound is not particularly limited. Examples thereof may include a dicarboxylic acid such as oxalic acid, malonic acid, succinic acid, glutaric acid, adipic acid, propyl malonic acid, or maleic acid; polyvalent hydroxycarboxylic acid such as malic acid, tartaric acid, or citric acid; aromatic polycarboxylic acid such as phthalic acid, isophthalic acid, hemimellitic acid, or trimellitic acid; and ethylenediaminetetraacetic acid, or the like. Two or more compounds among these may be concurrently used at the same time.

Meanwhile, all or some of the carboxyl group-containing compounds may be a neutralized product (for example, an organic compound having a —COONa group) of an organic compound having a —COOH group.

The inorganic acid is not particularly limited. Examples thereof may include hydrochloric acid, sulfuric acid, and nitric acid. The inorganic acid may be added so as to yield a concentration of from 0.5 to 2.5 mol/L and more preferably from 0.8 to 1.4 mol/L in a liquid for reaction (treatment).

The step (2) is preferably performed by suspending the compound obtained by the step (1) in pure water and optionally heating under stirring. The carboxyl group-containing compound and the inorganic acid may be added simultaneously or sequentially, but are preferably sequentially added. The addition may be performed such that the inorganic acid is added after the addition of the carboxyl group-containing compound or the carboxyl group-containing compound is added after the addition of the inorganic acid.

Examples of the method for performing the step (2) may include a method (method 1) which comprises adding the carboxyl group-containing compound into the suspension of the compound obtained by the step (1), starting heat the mixture, adding the inorganic acid thereto when the liquid temperature reaches preferably 60° C. or higher and more preferably 90° C. or higher, and stirring the mixture for preferably from 15 minutes to 5 hours and more preferably for 2 to 3 hours while maintaining the liquid temperature; and a method (method 2) which comprises heating the suspension of the compound obtained by the step (1), adding the inorganic acid thereto when the liquid temperature reaches preferably 60° C. or higher and more preferably 90° C. or higher, further adding the carboxyl group-containing compound thereto from 10 to 15 minutes after the addition of the inorganic acid, and stirring the mixture for preferably from 15 minutes to 5 hours and more preferably for 2 to 3 hours while maintaining the liquid temperature. By these methods, favorable fine particular rutile type titanium oxide can be obtained.

In the case of performing the step (2) by the method 1 above, the carboxyl group-containing compound is preferably used at a proportion of from 0.25 to 1.5 mol % and more preferably from 0.4 to 0.8 mol % with respect to 100 mol % of TiO₂. When the addition amount of the carboxyl group-containing compound is in the range above, particles having a desired particle size can be obtained, and rutile type particles can be more efficiently obtained.

In the case of performing the step (2) by the method 2 above, the carboxyl group-containing compound is preferably used at a proportion of from 1.6 to 4.0 mol % and more preferably from 2.0 to 2.4 mol % with respect to 100 mol % of TiO₂.

When the addition amount of the carboxyl group-containing compound is in the range above, particles having a desired particle size can be obtained, rutile type particles can be more efficiently obtained, and it is also economically advantageous. In addition, by adding the carboxyl group-containing compound from 10 to 15 minutes after the addition of the inorganic acid, rutile type particles can be more efficiently obtained, and particles having a desired particle size can be obtained.

In the step (2) above, after the completion of the reaction (treatment), the reaction product is preferably cooled and neutralized so as to have a pH level of from 5.0 to 10.0. The neutralization may be performed with an alkaline compound such as an aqueous solution of sodium hydroxide or ammonia water. The intended rutile type titanium oxide fine particles can be separate by filtering the neutralized prodcut and then washing with water.

In addition, as the manufacturing method of titanium oxide fine particles, it is possible to use a well-known method described in “Titanium oxide: properties and applied techniques” (SEINO Manabu pp 255 to 258 (2000) Gihodo Shuppan Co., Ltd.), or the like.

Moreover, as another manufacturing method of metal oxide particles including the titanium oxide particles, it is possible to see those described in Japanese Patent Application Laid-Open No. 2000-053421 (titanium oxide sol in which an alkyl silicate is blended as a dispersion stabilizer and a weight ratio (SiO₂/TiO₂) of an amount of silicon in the alkyl silicate in terms of SiO₂ and an amount of titanium in titanium oxide in terms of TiO₂ is from 0.7 to 10), Japanese Patent Application Laid-Open No. 2000-63119 (sol obtained by covering a surface of a composite colloidal particles of TiO₂—ZrO₂—SnO₂ as a core with composite oxide colloidal particles of WO₃—SnO₂—SiO₂), or the like.

Furthermore, titanium oxide particles may be covered with hydrated silicon-containing oxide. An amount of the hydrated silicon-containing compound covered is preferably from 3 to 30 mass %, more preferably from 3 to 10 mass %, and even more preferably from 3 to 8 mass %. When the covered amount is 30 mass % or less, a desired refractive index of the high refractive index layer can be obtained. When the covered amount is 3% or more, the particles can be stably formed.

As the method of covering the titanium oxide particles with the hydrated silicon-containing oxide, a method well-known in the related art can be used, and, for example, it is possible to see the matters described in Japanese Patent Application Laid-Open No. 10-158015 (treatment of rutile type titanium oxide with hydrated Si/Al oxide: a manufacturing method of titanium oxide sol which comprises surface-treatment by precipitating hydrated oxide of silicon and/or aluminum on a surface of titanium oxide after the peptization of titanate cake in an alkaline region), Japanese Patent Application Laid-Open No. 2000-204301 (sol obtained by covering rutile type titanium oxide with a composite oxide of Si and an oxide of Zr and/or Al. Hydrothermal treatment.) and Japanese Patent Application Laid-Open No. 2007-246351 (a method of manufacturing titanium oxide hydrosol covered with hydrated silicon oxide which comprises adding as a stabilizer an organoalkoxysilane represented by the Formula: R¹ₙSiX₄₋ₙ, (wherein R¹ represents a C1-C8 alkyl group, a glycidyloxy-substituted C1-C8 alkyl group, or a C2-C8 alkenyl group, X represents an alkoxy group, and n is 1 or 2) or a compound exhibiting complexing action with respect to titanium oxide to a hydrosol of titanium oxide obtained by peptization of hydrated titanium oxide, and adding the resultant mixture to a solution of sodium silicate or silica sol in an alkaline region, adjuting a pH level thereof, and aging), or the like.

A volume average particle size of the titanium oxide particles is preferably 30 nm or less, more preferably from 1 to 30 nm, and even more preferably from 5 to 15 nm. The volume average particle size of 30 nm or less is preferable from the viewpoint of less haze and excellent visible light transmissivity.

The volume average particle size as referred to herein is a volume average particle size of primary particles or secondary particles dispersed in a medium, and can be measured by a laser diffraction/scattering method, a dynamic light scattering method, or the like.

Specifically, particles themselves or particles appearing on the cross section or surface of a refractive index layer are observed using an electron microscope, a particle size of 1,000 arbitrary particles are measured, and then an average particle size is calculated which is weighted by a volume and represented by the Equation, volume average particle size mᵥ={Σ(vᵢ·dᵢ)}/{Σ(vᵢ)}, wherein vᵢ is a volume per particle in a population of metal oxide particles in which n₁, n₂, . . . nᵢ, . . . and nₖ particles having respectively a particle size of d₁, d₂, . . . dᵢ, . . . and dₖ, are present.

In addition, in the present invention, a colloidal silica composite emulsion can also be used as the metal oxide in a low refractive index layer. The colloidal silica composite emulsion preferably used in the present invention has a polymer, a copolymer, or the like as a main component of center of the particles, and can be obtained by polymerizing a monomer having an ethylenically unsaturated bond by an emulsion polymerization method well-known in the related art in the presence of colloidal silica described in Japanese Patent Application Laid-Open No. 59-71316 and Japanese Patent Application Laid-Open No. 60-127371. A particle size of the colloidal silica applicable to the composite emulsion is preferably less than 40 nm.

Examples of the colloidal silica used in the preparation of the composite emulsion may usually include colloidal silica having primary particles having a size of from 2 to 100 nm. Examples of the ethylenic monomer may include a material well-known in the latex industry such as a (meth)acrylic acid ester having an alkyl group having from 1 to 18 carbon atoms, an aryl group, or an allyl group, styrene, α-methyl styrene, vinyl toluene, acrylonitrile, vinyl chloride, vinylidene chloride, vinyl acetate, vinyl propionate, acrylamide, N-methylolacrylamide, ethylene, and butadiene. Furthermore, if necessary, a vinylsilane such as vinyltrimethoxysilane, vinyltriethoxysilane, or γ-methacryloxypropyltrimethoxysilane is used as an auxiliary in order to enhance compatibility with colloidal silica, and an anionic monomer such as (meth)acrylic acid, maleic acid, maleic anhydride, fumaric acid, or crotonic acid is used as an auxiliary for dispersion stability of the emulsion, respectively. Meanwhile, two or more kinds of ethylenic monomers can be used concurrently if necessary.

In addition, a ratio of ethylenic monomer/colloidal silica in the emulsion polymerization is preferably from 100/1 to 200 by a solid content ratio.

More preferred examples of the colloidal silica composite emulsion used in the present invention may include those having a glass transition point in the range of −30 to 30° C.

In addition, compositionally preferred examples may include an ethylenic monomer such as an acrylic acid ester or a methacrylic acid ester, and particularly preferred examples may include a copolymer of a (meth)acrylic acid ester and styrene, a copolymer of a (meth)acrylic acid alkyl ester and a (meth)acrylic acid aralkyl ester, and a copolymer of a (meth)acrylic acid alkyl ester and a (meth)acrylic acid aryl ester.

Examples of the emulsifier usable in the emulsion polymerization may include alkyl allyl polyether sulfonic acid sodium salts, lauryl sulfonic acid sodium salts, alkyl benzene sulfonic acid sodium salts, polyoxyethylene nonyl phenyl ether nitric acid sodium salts, alkyl allyl sulfosuccinic acid sodium salts, and sulfopropyl maleic acid monoalkyl ester sodium salts.

A content of the metal-containing particles in the first reflective film is preferably from 20 to 90 mass % and more preferably from 40 to 75 mass %, with respect to the total mass of the first reflective film. Similarly, a content of the metal-containing particles in the second reflective film is preferably from 20 to 90 mass % and more preferably from 40 to 75 mass %, with respect to the total mass of the second reflective film.

(Additive)

It is possible to incorporate various kinds of additives in the first reflective film and the second reflective film if necessary.

Specifically, it is possible to incorporate various kinds of well-known additives such as various kinds of anionic, nonionic or cationic surfactants; a dispersant such as polycarboxylic acid ammonium salts, allyl ether copolymers, benzenesulfonic acid sodium salts, graft compound-based dispersants, or polyethylene glycol type nonionic dispersants; organic acid salts such as acetate, propionate, or citrate; plasticizers such as organic ester plasticizers such as monobasic organic acid esters or polybasic organic acid esters, phosphoric acid plasticizers such as organic phosphoric acid plasticizers or organic phosphorous acid plasticizers; ultraviolet absorbers described in Japanese Patent Application Laid-Open No. 57-74193, Japanese Patent Application Laid-Open No. 57-87988, and Japanese Patent Application Laid-Open No. 62-261476, anti-fading agents described in Japanese Patent Application Laid-Open No. 57-74192, Japanese Patent Application Laid-Open No. 57-87989, Japanese Patent Application Laid-Open No. 60-72785, Japanese Patent Application Laid-Open No. 61-146591, Japanese Patent Application Laid-Open No. 1-95091, and Japanese Patent Application Laid-Open No. 3-13376; fluorescent whitening agents described in Japanese Patent Application Laid-Open No. 59-42993, Japanese Patent Application Laid-Open No. 59-52689, Japanese Patent Application Laid-Open No. 62-280069, Japanese Patent Application Laid-Open No. 61-242871, and Japanese Patent Application Laid-Open No. 4-219266; pH adjusting agents such as sulfuric acid, phosphoric acid, acetic acid, citric acid, sodium hydroxide, potassium hydroxide, and potassium carbonate; defoaming agents; lubricant such as diethylene glycol; preservatives; antistatic agents; and matting agents.

Meanwhile, an infrared shielding body of the present invention can have an appearance with a bluish color by incorporating a blue pigment or a blue dye in the first reflective film and/or the second reflective film.

(Manufacturing Method)

A manufacturing method of an infrared shielding body of the present invention is not particularly limited, but examples thereof may include a method which comprises wet coating an aqueous coating liquid on upper and lower surfaces of a light incoherent layer and drying the coating to form a laminated body. When the first reflective film and the second reflective film have a laminated structure having two or more layers, a method which comprises alternately wet coating an aqueous coating liquid for high refractive index layer and an aqueous coating liquid for low refractive index layer on upper and lower surfaces of a light incoherent layer, respectively, and drying the coating to form a laminated body.

As the method of alternately wet coating an aqueous coating liquid for high refractive index layer and an aqueous coating liquid for low refractive index layer, coating methods exemplified below are preferably used. For example, a roll coating method, a rod bar coating method, an air knife coating method, a spray coating method, a curtain coating method, or a slide hopper coating method (coating method by a slide coater) or an extrusion coating method described in U.S. Pat. No. 2,761,419, U.S. Pat. No. 2,761,791 and the like. In addition, a method of multilayer coating a plurality of layers may be a sequential multilayer extrusion coating or a simultaneous multilayer extrusion coating.

Viscosity of a coating liquid for a high refractive index layer and a coating liquid for a low refractive index layer during the simultaneous multilayer extrusion coating is preferably in the range of 5 to 100 mPa·s and more preferably from 10 to 50 mPa·s in the case of using a slide hopper coating method. In addition, viscosity thereof is preferably in the range of 5 to 1200 mPa·s and more preferably from 25 to 500 mPa·s in the case of using a curtain coating method.

In addition, viscosity of the coating liquid at 15° C. is preferably 100 mPa·s or more, more preferably from 100 to 30,000 mPa·s, even more preferably from 3,000 to 30,000 mPa·s, and most preferably 10,000 to 30,000 mPa·s.

A preferred coating and drying method comprises warming an aqueous coating liquid for high refractive index layer and an aqueous coating liquid for low refractive index layer to 30° C. or higher and coating, and then temporarily lowering a temperature of the coating thus formed to a temperature of from 1 to 15° C. and drying it at 10° C. or higher. More preferably, the drying is performed under conditions that a wet bulb temperature is in the range of 5 to 50° C. and a film surface temperature is in the range of 10 to 50° C. In addition, cooling immediately after coating is preferably performed by a horizontal setting method from the viewpoint of uniformity of the coating formed.

A thickness (thickness after drying) per layer of a high refractive index layer is preferably from 20 to 1000 nm and more preferably from 50 to 500 nm. A thickness (thickness after drying) per layer of a low refractive index layer is preferably from 20 to 800 nm and more preferably from 50 to 500 nm. When a certain reflection peak (λ) is set, a sub peak appears at a wavelength of one out of odd-number of λ in addition to λ main peak when both the low refractive index layer and the high refractive index layer are designed to be close to an optical film thickness n×d (refractive index*physical film thickness) of about ¼λ. It is possible to bring out an arbitrary reflected color by matching these peak wavelengths to arbitrary wavelengths.

With regard to the coating thickness, the coating liquid for high refractive index layer and the coating liquid for low refractive index layer may be coated so as to have the preferred thickness at the time of drying as indicated above.

The infrared shielding body of the present invention may comprise one or more functional layers on the first reflective film or the second reflective film for the purpose of imparting an additional function. Examples of the functional layer may include a conductive layer, an antistatic layer, a gas barrier layer, an easily adhesive layer (bonding layer), an antifouling layer, a deodorant layer, a dropping layer, an easily sliding layer, a hard coat layer, an abrasion resistant layer, an antireflection layer, an electromagnetic wave shielding layer, a ultraviolet absorbing layer, an infrared absorbing layer, a printing layer, a fluorescence emitting layer, a hologram layer, a release layer, an adhesive layer, a bonding layer, an infrared cutting layer other than the high refractive index layer and the low refractive index layer according to the present invention (a metal layer and a liquid crystal layer), a colored layer (visible light absorbing layer), and an intermediate film layer used in the laminated glass. Hereinafter, the adhesive layer, the infrared absorbing layer, and the hard coat layer which are the preferred functional layers will be explained.

<Adhesive Layer>

An adhesive constituting the adhesive layer is not particularly limited. Examples thereof may include an acrylic adhesive, silicon-based adhesives, urethane-based adhesives, polyvinyl butyral-based adhesives, and ethylene-vinyl acetate-based adhesives.

In the case of attaching the infrared shielding body of the present invention to a window glass, a method which comprises spraying water on a window glass and disposing the adhesive layer of the present infrared shielding body to the glass surface in the wet state, namely, a so-called attaching with water method can be suitably used from the view point of resticking, repositioning, or the like. Hence, an acrylic adhesive which shows weak adhesive force under wet conditions where water is present is preferably used.

The acrylic adhesive used may be either a solvent-based adhesive or an emulsion-based adhesive, but a solvent-based adhesive is preferable because of easy increase in adhesive force or the like. Those obtained by solution polymerization is preferable among the solvent-based adhesive. As a raw material used in manufacturing such a solvent-based acrylic adhesive by solution polymerization, for example, acrylic acid esters such as those having ethyl acrylate, butyl acrylate, 2-ethylhexyl acrylate, or octyl acrylate as a main monomer which constitutes the backbone may be cited. As a comonomer for improving cohesive force, vinyl acetate, acrylonitrile, styrene, methyl methacrylate, and the like may be exemplified. Moreover, as a functional group-containing monomer for promoting crosslinking, imparting stable adhesive force, and maintaining the adhesive force to a certain extent even in the presence of water, methacrylic acid, acrylic acid, itaconic acid, hydroxyethyl methacrylate, glycidyl methacrylate, and the like may be exemplified. The adhesive layer of the laminated film particularly advantageously contains an acrylic adhesive having a monomer having a low glass transition temperature (Tg) such as butyl acrylate in a main polymer particularly in terms of necessity of high tackiness.

The adhesive layer can contain an additive such as a stabilizer, a surfactant, a ultraviolet absorber, a flame retardant, an antistatic agent, an antioxidant, a heat stabilizer, a lubricant, a filler, a coloring agent, or an adhesion-adjusting agent. The addition of an ultraviolet absorber is effective particularly in the case of using the adhesive layer for attaching to a window glass as in the present invention in order to, suppress degradation of the infrared shielding body by ultraviolet rays as well.

A thickness of the adhesive layer is preferably from 1 μm to 100 μm and more preferably from 3 to 50 μm. The adhesiveness of the adhesive layer tends to be improved and thus sufficient adhesive force can be obtained when the thickness thereof is 1 μm or more. On the other hand, when the thickness thereof is 100 μm or less, not only transparency of the infrared shielding body can be improved but also cohesive failure between the adhesive layers would not occur when peeled off after the infrared shielding body is attached to a window glass, and thus adhesive residue on the glass surface would tend to decrease.

<Infrared Absorbing Layer>

The infrared shielding body according to the present invention can have an infrared absorbing layer in an arbitrary position.

The material contained in the infrared absorbing layer is not particularly limited, but examples thereof may include a ultraviolet curable resin, a photopolymerization initiator, and an infrared absorber.

The ultraviolet curable resin is superior in hardness and smoothness to other resins, and further is also advantageous from the viewpoint of dispersibility of tin-doped indium oxide (ITO), antimony-doped tin oxide (ATO), or a thermally conductive metal oxide. As the ultraviolet curable resin, any ultraviolet curable resin can be used without particular limitation as long as the ultraviolet curable resin forms a transparent layer by curing. Examples thereof may include silicone resins, epoxy resins, vinyl ester resins, acrylic resins, and allyl ester resins. An acrylic resin is more preferable from the viewpoint of hardness, smoothness, and transparency.

The acrylic resin preferably contains reactive silica particles having the surface introduced with a photosensitive group exhibiting photopolymerizable reactivity (hereinafter, also simply referred to as “reactive silica particles”) as described in WO 2008/035669 from the viewpoint of hardness, smoothness, and transparency. As used herein, a polymerizable unsaturated group represented by (meth)acryloyloxy group can be exemplified as the photosensitive group exhibiting photopolymerizability. In addition, the ultraviolet curable resin may contain a compound photopolymerizable with this photosensitive group exhibiting photopolymerizable reactivity which is introduced on the surface of reactive silica particles, for example, an organic compound having a polymerizable unsaturated group. In addition, it is possible to use reactive silica particles having a polymerizable unsaturated group-modified hydrolyzable silane chemically bonded via a silyloxy group produced between silica particles through hydrolysis reaction of the hydrolyzable silyl group. An average particle size of the reactive silica particles is preferably from 0.001 to 0.1 μm. It is possible to satisfy transparency, smoothness, and hardness in a favorable balance by setting the average particle size into such a range.

The acrylic resin may include a constituent unit derived from a fluorine-containing vinyl monomer from the viewpoint of adjusting the refractive index. Examples of the fluorine-containing vinyl monomer may include fluoro-olefins (for example, fluoroethylene, vinylidene fluoride, tetrafluoroethylene, hexafluoropropylene, or the like), partly or completely fluorinated alkyl ester derivatives of (meth)acrylic acid (for example, BISCOAT 6FM (trade name, manufactured by OSAKA ORGANIC CHEMICAL INDUSTRY LTD.), R-2020 (trade name, manufactured by DAIKIN INDUSTRIES, Ltd.), or the like), and completely or partly fluorinated vinyl ethers.

As the photopolymerization initiator, a well-known photopolymerization initiator can be used and the photopolymerization initiator can be used singly or in combination of two or more kinds thereof.

As the inorganic infrared absorber included in the infrared absorbing layer, tin-doped indium oxide (ITO), antimony-doped tin oxide (ATO), zinc antimonate, lanthanum hexaboride (LaB₆), cesium-containing tungsten oxide (Cs_{0.33}WO₃), and the like are preferable from the viewpoint of the visible light transmittance, infrared absorbability, and dispersion suitability in a resin. It is possible to use these singly or in combination of two or more kinds thereof. An average particle size of the inorganic infrared absorber is preferably from 5 to 100 nm and more preferably from 10 to 50 nm. There is a concern that dispersibility in a resin or infrared absorbability would decrease when the average particle size is less than 5 nm. On the other hand, there is a concern that visible light transmittance would decrease when the average particle size is greater than 100 nm. The average particle size can be measured by imaging particles by a transmission electron microscope, measuring a particle size of, for example, randomly extracted 50 particles, calculating an average of the measured results. The average particle size is defined as a value obtained by measuring a longest diameter of particles and calculating an average of the measured results, when the particles are not spherical.

A content of the inorganic infrared absorber in the infrared absorbing layer is preferably 1 to 80 mass % and more preferably 5 to 50 mass %, with respect to the total mass of the infrared absorbing layer. Sufficient infrared absorbing effects can be exerted when the content is 1 mass % or more, and sufficient quantity of visible light can be transmitted when the content is 80 mass % or less.

Another infrared absorber such as a metal oxide other than those mentioned above, an organic infrared absorber, or a metal complex may be contained in the infrared absorbing layer within the range in which the effect of the present invention can be exerted. Specific examples of such another infrared absorber may include diimonium-based compounds, aluminum-based compounds, phthalocyanine-based compounds, organometallic complexes, cyanine-based compounds, azo compounds, polymethine-based compounds, quinone-based compounds, diphenylmethane-based compounds, and triphenylmethane-based compounds.

A thickness of the infrared absorbing layer is preferably 0.1 to 50 μm and more preferably from 1 to 20 μm. The infrared absorption capacity could tend to be improved when the thickness is 0.1 μm or more. On the other hand, the crack resistance of the coating film can be improved when the thickness is 50 μm or less.

<Hard Coat Layer>

The infrared shielding body of the present invention preferably has as a surface protective layer to enhance abrasion resistance a hard coat layer which contains a resin to be cured by heat or ultraviolet rays and is disposed on the uppermost layer of the side opposite to the side having an adhesive layer of the substrate.

As the curable resin used in the hard coat layer, a thermosetting resin or an ultraviolet curable resin may be exemplified. A ultraviolet curable resin is preferable in terms of easy molding, and those having a pencil hardness of at least 2H are more preferable among them. Such curable resins can be used singly or in combination of two or more kinds thereof. In addition, as the curable resin, a commercially available product or a synthetic product may be used.

Examples of such an ultraviolet curable resin may include multifunctional acrylate resins such as acrylic acid or methacrylic acid ester having a polyhydric alcohol and multifunctional urethane acrylate resins such as those synthesized from diisocyanate and acrylic acid or methacrylic acid having a polyhydric alcohol. Moreover, polyether resins, polyester resins, epoxy resins, alkyd resins, spiroacetal resins, polybutadiene resins, polythiol polyene resins, or the like which have an acrylate-based functional group can also be suitably used.

It is possible to use a monomer or a oligomer having two or more functional groups such as 1,6-hexanediol di(meth)acrylate, tripropylene glycol di(meth)acrylate, diethylene glycol di(meth)acrylate, hexanediol (meth)acrylate, pentaerythritol tri(meth)acrylate, trimethylolpropane tri(meth)acrylate, dipentaerythritol hexa(meth)acrylate, or neopentyl glycol di(meth)acrylate, and acrylic acid esters such as N-vinyl pyrrolidone, ethyl acrylate, or propyl acrylate, methacrylic acid esters such as ethyl methacrylate, propyl methacrylate, isopropyl methacrylate, butyl methacrylate, hexyl methacrylate, isooctyl methacrylate, 2-hydroxyethyl methacrylate, cyclohexyl methacrylate, or nonylphenyl methacrylate, tetrahydrofurfuryl methacrylate and a derivative thereof such as a caprolactone modified product, and monofunctional monomers such as styrene, α-methylstyrene, or acrylic acid, which have a relatively low viscosity as a reactive diluent of these resins. These reactive diluents can be used singly or in combination of two or more kinds thereof.

Furthermore, it is possible to use benzoin and alkyl ethers thereof such as benzoin, benzoin methyl ether, benzoin ethyl ether, benzoin isopropyl ether, or benzyl methyl ketal; an acetophenones such as acetophenone, 2,2-dimethoxy-2-phenyl acetophenone, or 1-hydroxycyclohexyl phenyl ketone; anthraquinones such as methyl anthraquinone, 2-ethyl anthraquinone, or 2-amyl anthraquinone; thioxanthones such as thioxanthone, 2,4-diethyl thioxanthone, or 2,4-diisopropyl thioxanthone; ketals such as acetophenone dimethyl ketal or benzyl dimethyl ketal; benzophenones such as benzophenone or 4,4-bis-methyl-aminobenzophenone; and azo compounds as the photosensitizing agent (radical polymerization initiator) of these resins. These can be used singly or in combination of two or more kinds thereof. In addition, it is possible to use the photosensitizing agent in combination with a photoinitiation auxiliary such as a tertiary amine such as triethanolamine or methyl diethanolamine; and a benzoic acid derivative such as 2-dimethylaminoethyl benzoic acid or ethyl 4-dimethyl-aminobenzoate. A used amount of the radical polymerization initiator is preferably from 0.5 to 20 parts by mass and more preferably from 1 to 15 parts by mass, with respect to 100 parts by mass of the polymerizable component of the resin.

A generally well-known paint additive may be blended with the curable resin described if necessary. For example, a silicone-based or fluorine-based paint additive to impart leveling properties or surface slip properties can exhibit an effect of scratch resistance of cured film surface, and also the paint additive also bleeds out to the air interface in the case of using ultraviolet rays as the active energy ray and thus it is possible to decrease curing inhibition of resin by oxygen and to obtain an effective degree of curing even under low radiation intensity conditions.

In addition, the hard coat layer preferably contains inorganic fine particles. Examples of the preferred inorganic fine particles may include fine particles of an inorganic compound containing a metal such as titanium, silica, zirconium, aluminum, magnesium, antimony, zinc, or tin. An average particle size of the inorganic fine particles is preferably 1000 nm or less and more preferably in the range of 10 to 500 nm in terms of securing transparency of visible light. In addition, the inorganic fine particles preferably have a photosensitive group exhibiting photopolymerization reactivity such as monofunctional or polyfunctional acrylate introduced onto the surface thereof, since falling out of the inorganic fine particles from the hard coat layer can be suppressed when a bonding force with a curable resin forming the hard coat layer is strong.

A thickness of the hard coat layer is preferably from 0.1 to 50 μm and more preferably from 1 to 20 μm. When the thickness is 0.1 μm or more, the hard coat properties would tend to be improved. On the other hand, when the thickness is 50 μm or less, transparency of the infrared shielding body would tend to be improved.

Meanwhile, the hard coat layer may also serve as an infrared absorbing layer described above.

<Method of Forming Adhesive Layer, Infrared Absorbing Layer, and Hard Coat Layer>

As the coating method of the adhesive, an arbitrary well-known method can be used. Preferred examples thereof may include a bar coating method, a die coater method, a gravure roll coater method, a blade coater method, a spray coater method, an air knife coating method, a dip coating method, and a transfer method. These methods may be used singly or in combination. In the methods, the coating can be appropriately performed using a coating liquid obtained by dissolving the adhesive in a solvent capable of dissolving the adhesive or by dispersing the adhesive in a solvent. It is possible to use a well-known substance as the solvent.

The formation of the adhesive layer may be performed by directly coating on the infrared shielding body by the coating method described above, or by coating and drying on a release film temporarily and then bonding the resultant coating to a infrared shielding body to transfer the adhesive. At this time, a drying temperature is preferably set so as to be a residual solvent as little as possible. For this, a drying temperature and a drying time are not specified, but the drying temperature is preferably from 50 to 150° C. and the drying time is preferably from 10 seconds to 5 minutes. In addition, since the adhesive has fluidity and the reaction is not completed immediately after heating and drying, it is necessary to cure the adhesive in order to complete the reaction and to obtain stable adhesive force. In general, the curing is preferably performed for about one week or longer at room temperature or for three days or longer in the case of heating, for example, at 50° C. In the case of heating, the temperature should not be too high since there is a concern that flatness of a plastic film would deteriorate when the temperature is too high.

A method of forming the infrared absorbing layer and the hard coat layer is not particularly limited, but the formation thereof is preferably performed by a wet coating method such as a bar coating method, a die coater method, a gravure roll coater method, a spin coating method, a spraying method, a blade coating method, an air knife coating method, a dip coating method, or a transfer method, or a dry coating method such as a vapor deposition method.

With regard to a method of curing by ultraviolet radiation, curing may be performed by radiating ultraviolet rays in a wavelength region of preferably from 100 to 400 nm and more preferably from 200 to 400 nm emitted from a ultra-high pressure mercury lamp, a high pressure mercury lamp, a low pressure mercury lamp, a carbon arc, a metal halide lamp or the like, or by radiating an electron beam in a wavelength region of 100 nm or less emitted from a scanning type or curtain type electron beam accelerator.

The infrared shielding body of the present invention may be applied to a wide range of fields. The infrared shielding body is mainly used for the purpose of enhancing weather resistance, for example, as a film for attaching to a window glass such as a heat reflecting film which is attached to facilities exposed to sunlight for a long period of time, such as an outdoor window of building or a motor vehicle window so as to impart heat reflecting effects, or an agricultural plastic greenhouse film. In addition, the infrared shielding body is also suitably used as an infrared shielding body for motor vehicle which is sandwiched between the glasses such as a laminated glass for motor vehicle. This case is preferable from the viewpoint of durability since the infrared shielding body can be sealed from the outside air.

In particular, the infrared shielding body according to the present invention can be suitably used in the members attached to a substrate such as glass or a resin alternative to the glass directly or via an adhesive.

Preferred examples of the substrate may include a plastic substrate, a metal substrate, a ceramic substrate, and a cloth-like substrate. It is possible to provide the infrared shielding body of the present invention to a substrate having various shapes such as a film-like shape, a plate-like shape, a spherical shape, a cubic shape, and a rectangular parallelepiped shape. Among these, a ceramic substrate having a plate-like shape is preferable. In accordance with a more preferable embodiment, the infrared shielding body of the present invention is provided to a glass plate. Examples of the glass plate may include float plate glass and polished plate glass described in JIS R3202: 1996. A thickness of the glass is preferably from 0.01 mm to 20 mm.

As a method of providing the infrared shielding body of the present invention to a substrate, a method which comprises providing by coating an adhesive layer on the infrared shielding body as described above and attaching the infrared shielding body to a substrate via the adhesive layer can be suitably used.

As an attaching method, a dry type attaching method of attaching a film to a substrate as it is and an attaching method of attaching with water as described above can be applied, but the attaching method of attaching with water is more preferable in order to prevent air from entering between the substrate and the infrared shielding body and from the viewpoint of easy construction such as positioning of the infrared shielding body on the substrate.

The embodiment described above is an aspect in which the infrared shielding body of the present invention is provided on at least one surface of a substrate, but it may be an aspect in which the infrared shielding body of the present invention is provided on a plurality of surfaces of a substrate or an aspect in which a plurality of substrates is provided to the infrared shielding body of the present invention. For example, it may be an aspect in which the infrared shielding body of the present invention is provided on both surfaces of the plate glass described above or an aspect in which an adhesive layer is coated on both surfaces of the infrared shielding body of the present invention and the plate glass described above is attached on both surfaces of the infrared shielding body to form a laminated glass shape. In the case of an aspect of forming a laminated glass shape, the infrared shielding body is exposed in a significantly severe atmosphere in the laminated glass processing step. For example, the infrared shielding body is introduced into an autoclave apparatus and exposed to a high temperature as of 150° C. or higher. According to the present invention, it is possible to suppress film cracking even in this case.

### EXAMPLES

Hereinafter, the present invention will be described in further detail with reference to Examples, but the present invention is not limited to these Examples. Meanwhile, the term “parts” or “%” used in Examples represents “parts by mass” or “% by mass” unless otherwise stated.

### Example 1

### Example 1-1

<Preparation of Tabular Silver Particle Dispersion>

To a solution consisting of 762 g of ion exchanged water, 12.7 mg of silver nitrate (manufactured by Wako Pure Chemical Industries, Ltd.), 100.6 mg of sodium citrate trihydrate (manufactured by Wako Pure Chemical Industries, Ltd.), and 22.5 mg of disodium ethylenediaminotetraacetate (manufactured by Wako Pure Chemical Industries, Ltd.), 0.85 mL of 150 mM aqueous solution of hydrazine was added at once followed by stirring at 25° C. and 1,000 rpm for 2 hours so as to obtain a silver particle dispersion exhibiting a turbid blue color.

It was confirmed that tabular silver particles of a substantially hexagonal shape (hereinafter, also referred to as the tabular silver particles) having an average particle size (average equivalent circle diameter) of 240 nm are formed in the resultant silver particle dispersion. In addition, the thickness of the tabular silver particles was measured by an atomic force microscope (Nanocute II manufactured by Seiko Instruments Inc.) to find to be 20 nm, and it was also found that tabular silver particles having an aspect ratio of 12 were produced.

To the tabular silver particle dispersion thus obtained, 1200 ml of 0.04 N aqueous solution of sodium hydroxide was added, and the mixture divided into 6 parts and subjected to centrifugation at 3500 rpm for 5 minutes by a centrifuge (SCR20B, manufactured by Hitachi, Ltd.) while cooling. A supernatant was discharged, the residue was washed once with pure water and centrifuged, and a supernatant was discharged again. To the tabular silver particles remaining in the centrifuge tube, 150 ml of pure water was added to each of the tubes and the mixture was dispersed by stirring, and then 2 ml of a mixed solution of water and isopropanol (water:isopropanol=1:1 (volume ratio)) was added to each of the tubes and stirred so as to obtain a tabular silver particle dispersion.

The tabular silver particle dispersion thus obtained was coated on a polyester film (50 μm thick) which had been subjected to corona discharge as the light incoherent layer using a #14 wire bar, on which a 5 vol % aqueous solution of pigskin alkali-treated gelatin (BD230, manufactured by Nippi. Inc.) was coated at a thickness of 20 μm using a blade coater, set at 15° C. and dried at 45° C. so as to provide a layer of pigskin alkali-treated gelatin having a thickness of 1 μm, whereby a first reflective film was formed.

Thereafter, the polyester film was turned over and the tabular silver particle dispersion obtained above was similarly coated using a #14 wire bar. On this, a 5 vol % aqueous solution of pigskin alkali-treated gelatin (BD230, manufactured by Nippi. Inc.) was coated at a thickness of 20 μm using a blade coater, set at 15° C. and dried at 45° C. so as to provide a layer of pigskin alkali-treated gelatin having a thickness of 1 μm, whereby a second reflective film was formed. By this, an infrared shielding body of Example 1-1 was obtained.

### Example 1-2

### Preparation of Aqueous Dispersion of Titanium Oxide Sol

To 10 L of aqueous suspension (TiO₂ concentration of 100 g/L) prepared by suspending titanium oxide hydrate in water, 30 L of aqueous solution of sodium hydroxide (concentration of 10 mol/L) was added under stirring, and the temperature thereof was raised to 90° C. and aged for 5 hours, and then the resultant was neutralized with hydrochloric acid, filtered, and washed with water. Meanwhile, titanium oxide hydrate used in the above reaction (treatment) was obtained by the thermal hydrolysis of aqueous titanium tetrachloride solution in accordance with a well-known technique.

The titanium compound obtained by the base treatment above was suspended in pure water so as to have a TiO₂ concentration of 20 g/L, and citric acid was added thereto at 0.4 mol % with respect to the amount of TiO₂ under stirring and the temperature of the mixture was raised. When the solution temperature reached 95° C., concentrated hydrochloric acid was added thereto so as to have a hydrochloric acid concentration of 30 g/L, and the mixture was stirred for 3 hours while maintaining the solution temperature, so as to obtain a aqueous dispersion of titanium oxide sol.

The pH and the zeta potential of the aqueous dispersion of titanium oxide sol thus obtained was measured, to find that the pH was 1.4 and the zeta potential was +40 mV. Furthermore, the particle size thereof was measured by the Zetasizer Nano manufactured by Malvern Instruments Ltd, to find that the volume average particle size was 35 nm and the monodispersity was 16%.

To 1 kg of 20.0 mass % aqueous dispersion of titanium oxide sol containing the rutile type titanium oxide particles having a volume average particle size of 35 nm, 1 kg of pure water was added so as to adjust the concentration to 10.0 mass %.

Preparation of Aqueous Solution of Silicic Acid

An aqueous solution of silicic acid having a SiO₂ concentration of 2.0 mass % was prepared.

Preparation of Silica-Modified Titanium Oxide Particles

To 0.5 kg of the 10.0 mass % aqueous dispersion of titanium oxide sol obtained above, 2 kg of pure water was added and then the mixture was heated to 90° C. Thereafter, 1.3 kg of 2.0 mass % aqueous solution of silicic acid was added thereto gradually. Subsequently, the dispersion thus obtained was subjected to heat treatment at 175° C. for 18 hours in an autoclave, and further concentrated, so as to obtain a 20 mass % aqueous dispersion of silica-modified titanium oxide particles comprising titanium oxide with a rutile type structure and a covering layer of SiO₂.

(Preparation of Coating Liquid L for Low Refractive Index Layer)

To 460 parts of 15.0 mass % oxide silica sol (volume average particle size of 15 nm, silicon dioxide particles (trade name: PL-1, manufactured by FUSO CHEMICAL CO., LTD.)), 30 parts of a 4.0 mass % aqueous solution of silanol-modified polyvinyl alcohol (R-1130, manufactured by KURARAY CO., LTD.) and 150 parts of a 3.0 mass % aqueous solution of boric acid were mixed, respectively. Thereafter, the mixture was added with pure water so as to be 1000 parts in total, to prepare a dispersion.

Subsequently, the dispersion obtained above was heated to 38° C., and 760 parts of 4.0 mass % aqueous solution of modified polyvinyl alcohol (EXCEVAL (registered trademark) RS-2117, manufactured by KURARAY CO., LTD., saponification degree of 88 mol %, polyvinyl alcohol (a) or (c)) was added thereto while stirring, and then 40 parts of a 1 mass % aqueous solution of Softazoline (registered trademark) LSB-R (manufactured by Kawaken Fine Chemical Co., Ltd.) was added thereto, so as to prepare a coating liquid L for low refractive index layer.

(Preparation of Coating Liquid H for High Refractive Index Layer)

28.9 parts of 20 mass % silica-modified titanium oxide sol obtained above and 9.0 parts of 3 mass % aqueous solution of boric acid were mixed together. Then, 33.5 parts of 5.0 mass % aqueous solution of polyvinyl alcohol (JF-17, manufactured by JAPAN VAM & POVAL CO., LTD., saponification degree of 99 mol %, polyvinyl alcohol (b) or (d)) was added to 16.3 parts of pure water. Subsequently, 0.5 part of 1 mass % aqueous solution of Softazoline (registered trademark) LSB-R (manufactured by Kawaken Fine Chemical Co., Ltd.) was added thereto, and finally the mixture was added with pure water so as to be 1000 parts in total, to prepare a coating liquid H for high refractive index layer.

The coating liquid-L for low refractive index layer and the coating liquid H for high refractive index layer were alternately coated on a polyester film (50 thick) as a light incoherent layer which had been subjected to easily adhesive process using a slide coater, and dried so as to form a first reflective film having nine layers. Meanwhile, refractive index of the low refractive index layer formed from the coating liquid L for low refractive index layer was 1.45, and refractive index of the high refractive index layer formed from the coating liquid H for high refractive index layer was 1.90.

Subsequently, the polyester film was turned over, and the coating liquid L for low refractive index layer and the coating liquid H for high refractive index layer were alternately coated thereon using a slide coater similarly as above, and dried, so as to form a second reflective film having nine layers, whereby the infrared shielding body of Example 1-2 was prepared.

Meanwhile, a dry film thickness of each of the layers of the infrared shielding body thus obtained is as shown in Table 2.

### Example 1-3

The coating liquid L for low refractive index layer and the coating liquid H for high refractive index layer obtained above were alternately coated on a polyester film subjected to easily adhesive process using a slide coater of which the number of layers was set to 17 layers, and dried, so as to form a first reflective film having 17 layers. Thereafter, the polyester film was turned over, and the coating liquid L for low refractive index layer and the coating liquid H for high refractive index layer were alternately coated thereon using a slide coater set to 15 layers and dried so as to form a second reflective film having 15 layers, whereby the infrared shielding body of Example 1-3 was prepared.

Meanwhile, a dry film thickness of each of the layers of the infrared shielding body thus obtained is as shown in Table 2.

### Example 1-4

The coating liquid L for low refractive index layer and the coating liquid H for high refractive index layer obtained above were alternately coated on a polyester film subjected to easily adhesive process using a slide coater of which the number of layers was set to 21 layers, and dried, so as to form a first reflective film having 21 layers. Thereafter, the polyester film was turned over, and the coating liquid L for low refractive index layer and the coating liquid H for high refractive index layer were alternately coated thereon using a slide coater set to 19 layers and dried so as to form a second reflective film having 19 layers, whereby the infrared shielding body of Example 1-4 was prepared.

Meanwhile, a dry film thickness of each of the layers of the infrared shielding body thus obtained is as shown in Table 2.

### Example 1-5

The coating liquid L for low refractive index layer and the coating liquid H for high refractive index layer obtained above were alternately coated on a polyester film subjected to easily adhesive process using a slide coater of which the number of layers was set to 21 layers, and dried, so as to form a first reflective film having 21 layers. Thereafter, the polyester film was turned over, and the coating liquid L for low refractive index layer and the coating liquid H for high refractive index layer were alternately coated thereon using a slide coater set to 21 layers and dried so as to form a second reflective film having 21 layers, whereby the infrared shielding body of Example 1-5 was prepared.

Meanwhile, a dry film thickness of each of the layers of the infrared shielding body thus obtained is as shown in Table 2.

### Comparative Example 1-1

Silica and titanium oxide were alternately laminated on a polyester film in this order using a sputtering apparatus (SC-701 MkII, manufactured by Sanyu Electron Co., Ltd.) such that a thickness of silica was 161 nm, a thickness of titanium oxide was 101 nm, and six layers were laminated in total to have three layers for each.

Thereafter, the polyester film was turned over, and silica and titanium oxide were alternately laminated thereon in this order similarly such that a thickness of silica was 180 nm, a thickness of titanium oxide was 112 nm, and six layers were laminated in total to have three layers for each, whereby the infrared shielding body of Comparative Example 1-1 was obtained.

### Comparative Example 1-2

The tabular silver particle dispersion prepared in Example 1-1 was coated on a polyester film which had been subjected to corona discharge using a #14 wire bar. On this, a 5 vol % aqueous solution of pigskin alkali-treated gelatin (BD230, manufactured by Nippi. Inc.) was coated at a thickness of 20 μm using a blade coater, and the resultant was set at 15° C. and dried at 45° C. so as to provide a layer of pigskin alkali-treated gelatin having a thickness of 1 μm, whereby the infrared shielding body of Comparative Example 1-2 was obtained.

### Comparative Example 1-3

The film that prepared in Comparative Example 1-2 was subjected to corona discharge, and the tabular silver particle dispersion prepared in Example 1-1 was coated thereon using a #14 wire bar. On this, a 5 vol % aqueous solution of gelatin was coated at a thickness of 20 μm using a blade coater, and the resultant was set at 15° C. and dried at 45° C. so as to provide a layer of pigskin alkali-treated gelatin (BD230, manufactured by Nippi. Inc.) having a thickness of 1 μm, whereby the infrared shielding body of Comparative Example 1-3 was obtained.

### Comparative Example 1-4

The coating liquid L for low refractive index layer and the coating liquid H for high refractive index layer obtained above were coated on a polyester film which had been subjected to easily adhesive process using a slide coater of which the number of layers was set to nine layers, and dried so as to form a first reflective film having nine layers. Thereafter, the coating liquid L for low refractive index layer and the coating liquid H for high refractive index layer were coated again on the reflective film formed above using a slide coater set to nine layers, and dried so as to further form a reflective film, whereby the infrared shielding body of Comparative Example 1-4 was prepared.

Meanwhile, a dry film thickness of each of the layers of the infrared shielding body thus obtained is as shown in Table 2.

### Comparative Example 1-5

The infrared shielding body of Comparative Example 1-5 was obtained similarly as in Comparative Example 1, except that the polyester film was not turned over, and silica and titanium oxide were alternately laminated on the polyester film in this order such that a thickness of silica was 161 nm, a thickness of titanium oxide was 101 nm, and 12 layers were laminated in total to have six layers for each.

### Comparative Example 1-6

On an unstretched polyethylene terephthalate film having a thickness of 50 μm, extrusion was performed by an extruder as described in Japanese Patent Application Laid-Open No. 4-268505, so that PMMA having a thickness of 1.51 μm and PEN having a thickness of 1.45 μm were alternately laminated on one surface to have 64 layers in total, then PET having a thickness of 50 μm, and PEN having a thickness of 1.49 μM and PMMA having a thickness of 1.55 μm were alternately laminated on the other surface to have 64 layers in total, and then stretched by 3.3 times in the longitudinal direction and 3.3 times in a transverse direction, thereby obtaining the infrared shielding body of Comparative Example 1-6 having a reflection spectrum in the near infrared region.

### Comparative Example 1-7

On an unstretched polyethylene terephthalate film having a thickness of 50 μm, extrusion was performed by an extruder as described in Japanese Patent Application Laid-Open No. 4-268505, so that PMMA having a thickness of 1.51 μm and PEN having a thickness of 1.45 μm were alternately laminated on one surface to have 128 layers in total, and then stretched by 3.3 times in the longitudinal direction and 3.3 times in a transverse direction, thereby obtaining the infrared shielding body of Comparative Example 1-7 having a reflection spectrum in the near infrared region.

TABLE 2

| | Example | | | | Comparative |
|---|---|---|---|---|---|
| | 1-2 | Example 1-3 | Example 1-4 | Example 1-5 | Example 1-4 |
| 21 | | | 86 nm | 108 nm | |
| 20 | | | 129 nm | 281 nm | |
| 19 | | | 175 nm | 290 nm | |
| 18 | | | 135 nm | 239 nm | 80 nm |
| 17 | | 283 nm | 177 nm | 303 nm | 109 nm |
| 16 | | 138 nm | 136 nm | 165 nm | 177 nm |
| 15 | | 168 nm | 177 nm | 238 nm | 110 nm |
| 14 | | 126 nm | 134 nm | 112 nm | 155 nm |
| 13 | | 155 nm | 175 nm | 180 nm | 133 nm |
| 12 | | 122 nm | 133 nm | 248 nm | 174 nm |
| 11 | | 158 nm | 174 nm | 186 nm | 146 nm |
| 10 | | 122 nm | 132 nm | 125 nm | 185 nm |
| 9 | 120 nm | 157 nm | 172 nm | 185 nm | 132 nm |
| 8 | 135 nm | 122 nm | 130 nm | 139 nm | 137 nm |
| 7 | 166 nm | 158 nm | 170 nm | 167 nm | 171 nm |
| 6 | 132 nm | 127 nm | 131 nm | 128 nm | 126 nm |
| 5 | 166 nm | 156 nm | 175 nm | 173 nm | 165 nm |
| 4 | 132 nm | 128 nm | 135 nm | 136 nm | 124 nm |
| 3 | 166 nm | 171 nm | 180 nm | 176 nm | 162 nm |
| 2 | 134 nm | 141 nm | 142 nm | 142 nm | 125 nm |
| 1 | 498 nm | 454 nm | 546 nm | 410 nm | 171 nm |

Light incoherent layer

| | | | | |
|---|---|---|---|---|
| 1 | 498 nm | 489 nm | 485 nm | 410 nm |
| 2 | 134 nm | 156 nm | 145 nm | 142 nm |
| 3 | 166 nm | 193 nm | 193 nm | 176 nm |
| 4 | 132 nm | 146 nm | 151 nm | 136 nm |
| 5 | 166 nm | 190 nm | 197 nm | 173 nm |
| 6 | 132 nm | 146 nm | 148 nm | 128 nm |
| 7 | 166 nm | 190 nm | 194 nm | 167 nm |
| 8 | 135 nm | 144 nm | 149 nm | 139 nm |
| 9 | 120 nm | 189 nm | 198 nm | 185 nm |
| 10 | | 145 nm | 150 nm | 125 nm |
| 11 | | 190 nm | 194 nm | 186 nm |
| 12 | | 145 nm | 149 nm | 248 nm |
| 13 | | 194 nm | 199 nm | 180 nm |
| 14 | | 148 nm | 152 nm | 112 nm |
| 15 | | 379 nm | 193 nm | 238 nm |
| 16 | | | 146 nm | 165 nm |
| 17 | | | 205 nm | 303 nm |
| 18 | | | 165 nm | 239 nm |
| 19 | | | 95 nm | 290 nm |
| 20 | | | | 281 nm |
| 21 | | | | 108 nm |

Remark)
In Examples 1-2 to 1-5, the bold letters represent the first reflective film, and the thin letters represent the second reflective film.

(Evaluation)

(Infrared Reflection Spectrum)

Infrared reflection spectrum was measured at a resolution of 1 nm using V-670 manufactured by JASCO Corporation. A maximum half width is a difference of wavelengths at two locations showing half reflectivity of the maximum reflectivity.

(Evaluation of Distortion of Image and Film Cracking)

The films obtained in Examples 1-1 to 1-5 and Comparative Examples 1-1 to 1-7 were repeatedly exposed in an atmosphere of 80% RH and 60° C. for 1 hour and then in an atmosphere of 20% RH and 55° C. for 1 hour 1000 times (severe condition cycle), and the evaluation was performed by the following method for measurement.

(Distortion of Image)

A graph paper was pasted on a white wall at a distance of 1 m, and a laser pointer was set to hit the graph paper vertically, and a diameter (X0) and positions (x, y) of the pointer on the wall were measured, and the position in this state was taken as (0, 0).

The infrared shielding body was hung from a ceiling between the laser pointer and the wall and 10 cm away from the laser pointer so as to be parallel to the wall. A diameter (broadens when being scattered) and positions (x, y) of the pointer on the wall were measured for 10 points of the infrared shielding body. A diameter of the part at which the diameter was the largest in the 10 points was denoted as Y0, and judged according to the following criteria.

5: Y0/X0=1.00 or more and less than 1.05

4: Y0/X0=1.05 or more and less than 1.50

3: Y0/X0=1.50 or more and less than 2.00

2: Y0/X0=2.00 or more and less than 5.00

1: Y0/X0=5.00 or more.

In addition, since the position of the pointer is shifted when the flatness of the film is lost, a shift (Z) was calculated by the equation: Z=(x²+y²)^{1/2}, and the maximum shift of the 10 points was determined.

(Film Cracking)

The film was observed visually and by a magnifying lens of 100 magnifications, to evaluate cracking of the laminated film according to the following criteria.

5: No cracks are observed in 300 mm×300 mm even when observed by a magnifying lens of 100 magnifications

4: No cracks are visually observed in 300 mm×300 mm, but 3 or less cracks are observed therein by a magnifying lens of 100 magnifications

3: No cracks are visually observed in 300 mm×300 mm, but 4 or more and 10 or less cracks are observed by a magnifying lens of 100 magnifications

2: 3 or less cracks are visually observed in 300 mm×300 mm

1: 4 or more and 10 or less cracks are visually observed in 300 mm×300 mm

0: 10 or more cracks are visually observed in 300 mm×300 mm.

The evaluation results of the infrared shielding bodies of Examples 1-1 to 1-5 and Comparative Examples 1-1 to 1-7 are shown in the following Table 3.

TABLE 3

| | | | | | | | | | Distortion | | |
|---|---|---|---|---|---|---|---|---|---|---|---|
| | First reflective | | Second reflective | | | Reflection spectrum | | | of image | | Film |
| | film | | film | | | Maximum | Peak | Peak half | (after severe | | cracking |
| | | Number | | Number | Light | peak | reflec- | value | condition | | after severe |
| | | of | | of | incoherent | wavelength | tivity | width | cycle) | | condition |
| | Constitution | layers | Constitution | layers | layer | (nm) | (%) | (nm) | Y0/X0 | Z | cycle |
| Example 1-1 | Tabular silver | 1 | Tabular silver | 1 | Presence | 1000 | 30 | 170 | 4 | 0 | 3 |
| | particles + | | particles + | | | | | | | | |
| | gelatin | | gelatin | | | | | | | | |
| Example 1-2 | PVA(a) + SiO₂ | 9 | PVA(c) + SiO₂ | 9 | Presence | 1100 | 70 | 170 | 4 | 0 | 5 |
| | PVA(b) + TiO₂ | | PVA(d) + TiO₂ | | | | | | | | |
| Example 1-3 | PVA(a) + SiO₂ | 17 | PVA(c) + SiO₂ | 15 | Presence | 1100 | 80 | 250 | 5 | 0 | 4 |
| | PVA(b) + TiO₂ | | PVA(d) + TiO₂ | | | | | | | | |
| Example 1-4 | PVA(a) + SiO₂ | 21 | PVA(c) + SiO₂ | 19 | Presence | 1100 | 95 | 400 | 5 | 0 | 5 |
| | PVA(b) + TiO₂ | | PVA(d) + TiO₂ | | | | | | | | |
| Example 1-5 | PVA(a) + SiO₂ | 21 | PVA(c) + SiO₂ | 21 | Presence | 1100 | 90 | 590 | 5 | 0 | 5 |
| | PVA(b) + TiO₂ | | PVA(d) + TiO₂ | | | | | | | | |
| Comparative | SiO₂ | 6 | SiO₂ | 6 | Presence | 1100 | 90 | 560 | 3 | 20 | 0 |
| Example 1-1 | TiO₂ | | TiO₂ | | | | | | | | |
| Comparative | Tabular silver | 1 | Absence | — | Absence | 1000 | 15 | 130 | 3 | 5 | 1 |
| Example 1-2 | particles + | | | | | | | | | | |
| | gelatin | | | | | | | | | | |
| Comparative | Tabular silver | 2 | Absence | — | Absence | 1000 | 13 | 170 | 1 | 15 | 1 |
| Example 1-3 | particles + | | | | | | | | | | |
| | gelatin | | | | | | | | | | |
| Comparative | PVA(a) + SiO₂ | 18 | Absence | — | Absence | 1100 | 55 | 170 | 3 | 7 | 2 |
| Example 1-4 | PVA(b) + TiO₂ | | | | | | | | | | |
| Comparative | SiO₂ | 12 | Absence | — | Absence | 1100 | 98 | 450 | 3 | 20 | 0 |
| Example 1-5 | TiO₂ | | | | | | | | | | |
| Comparative | PMMA | 64 | PMMA | 64 | Presence | 1100 | 75 | 80 | 3 | 10 | 1 |
| Example 1-6 | PEN | | PEN | | | | | | | | |
| Comparative | PMMA | 128 | Absence | — | Absence | 1100 | 85 | 75 | 3 | 15 | 1 |
| Example 1-7 | PEN | | | | | | | | | | |

As can be seen from Table 3, the infrared shielding body of the present invention have a favorable infrared reflectivity and a favorable peak half value width in the reflection spectrum. In addition, it was verified that cracking of film can be suppressed and distortion of visible image hardly occurs.

### Example 2

### Example 2-1

A laminated glass was prepared using the infrared shielding body of Example 1-1 in the following manner.

To 485 g of PVB (TROSIFOL (registered trademark) VG, manufactured by KURARAY CO., LTD., polyvinyl butyral) resin, 10 g of 20 wt % ATO (conductive antimony-containing tin oxide) ultra-fine particle (particle size of 0.02 μm or less) dispersion containing DOP (dioctyl phthalate) and 130 g of normal DOP were added, and the mixture was kneaded and mixed together with another ultraviolet absorber or the like at about 70° C. for about 15 minutes by a three-roll mixer. The raw material resin for film formation thus obtained was formed into a film having a thickness of about 0.4 mm at about 190° C. by a mold extruder and wound to a roll, so as to prepare an intermediate film A. Meanwhile, crimps having uniform convexoconcave were formed on the surface of the film.

The intermediate film B was prepared similarly as in the preparation of the intermediate film A except that ATO was not added.

Next, two clear glass substrates having a size of about 300 mm×300 mm and a thickness of about 2.3 mm (FL 2.3) were provided, and the films prepared above were cut into the same size as the substrates. Then, the intermediate film A prepared above was placed on the clear glass substrate, the infrared shielding body of Example 1-1 was placed on it, and the intermediate film B and the clear glass substrate were further laminated thereon in this order, so as to obtain a laminated body. Subsequently, the laminated body was introduced into a vacuum bag made of rubber, and the inside of the bag was degassed to reduce the pressure. Then, the state was maintained at about 80 to 110° C. for about 20 to 30 minutes, and then the temperature was changed to room temperature temporarily. Subsequently, the laminated body taken out from the bag was introduced into an autoclave apparatus and autoclaved at a pressure of about 14 kg/cm² and a temperature of about 160° C. for about 40 minutes, so as to perform a treatment for forming a laminated glass.

### Example 2-2

An infrared shielding body was prepared by forming a first reflective film similarly as in Example 1-1 on one surface of a polyester film and forming a second reflective film similarly as in Example 1-3 on the other surface thereof.

A laminated glass was prepared similarly as in Example 2-1 except using the resultant infrared shielding body instead.

### Example 2-3

A laminated glass was prepared similarly as in Example 2-1 except using the infrared reflective film obtained in Example 1-3 instead of the infrared shielding film obtained in Example 1-1.

### Comparative Example 2-1

A laminated glass was prepared similarly as in Example 2-1 except using the infrared reflective film obtained in Comparative Example 1-1 instead of the infrared shielding film obtained in Example 1-1.

### Comparative Example 2-2

A laminated glass was prepared similarly as in Example 2-1 except using the infrared reflective film obtained in Comparative Example 1-5 instead of the infrared shielding film obtained in Example 1-1.

### Comparative Example 2-3

A laminated glass was prepared similarly as in Example 2-1 except using the infrared reflective film obtained in Comparative Example 1-6 instead of the infrared shielding film obtained in Example 1-1.

(Evaluation)

(Film Cracking)

The laminated glasses thus obtained were repeatedly exposed in the same conditions as in Example 1, that is, in an atmosphere of 80% RH and 60° C. for 1 hour and then in an atmosphere of 20% RH and 55° C. for 1 hour 1000 times (severe condition cycle), and the evaluation on the film cracking was performed by the following method for measurement. The results are shown in Table 4. Meanwhile, at the time of performing the severe condition cycle, only the glass surface adjacent to the intermediate film A of the laminated glass was exposed to the severe condition cycle and the other glass surface was in an atmosphere of 55% RH and 23° C.

The film was observed visually and by a magnifying lens of 100 magnifications, and the cracking of the film was evaluated according to the same criteria as those in Example 1.

TABLE 4

| Kind of laminated glass | Evaluation on film cracking |
|---|---|
| Example 2-1 | 5 |
| Example 2-2 | 4 |
| Example 2-3 | 5 |
| Comparative Example 2-1 | 0 |
| Comparative Example 2-2 | 1 |
| Comparative Example 2-3 | 1 |

As can be seen from Table 4, film cracking can be suppressed in the laminated glass equipped with the infrared shielding body of the present invention.

Meanwhile, this application is based upon and claims the benefit of priority of the prior Japanese Patent Application No. 2012-124799, filed on May 31, 2012, the entire contents of which are incorporated herein by reference.

### EXPLANATIONS OF LETTERS OR NUMERALS

10 Infrared shielding body
11 First reflective film
12 Light incoherent layer
13 Second reflective film
14 Layer (A)
15 Layer (B)
16 Layer (C)
17 Layer (D)

1. An infrared shielding body having a wavelength exhibiting a maximum reflectivity in the range of 850 nm to 1500 nm in a reflection spectrum of a wavelength from 400 nm to 2500 nm, the infrared shielding body comprising a first reflective film, a light incoherent layer, and a second reflective film laminated in this order,
wherein the first reflective film and the second reflective film contain a polymer and metal-containing particles.

2. The infrared shielding body according to claim 1, wherein the first reflective film is an alternately laminated body of a layer (A) containing at least polyvinyl alcohol (a) and silicon oxide particles and a layer (B) containing at least polyvinyl alcohol (b) having a saponification degree different from that of the polyvinyl alcohol (a) and titanium oxide particles, and
the second reflective film is an alternately laminated body of a layer (C) containing at least polyvinyl alcohol (c) and silicon oxide particles and a layer (D) containing at least polyvinyl alcohol (d) having a saponification degree different from that of the polyvinyl alcohol (c) and titanium oxide particles.

3. The infrared shielding body according to claim 1, wherein the first reflective film and the second reflective film have a laminated structure having 15 or more layers.
